(19) United States
(12) Patent Application Publication
(10) Pub. No.: US 2005/0195077 A1
(43) Pub. Date: Sep. 8, 2005

(54) Communication of long term care information

(75) Inventors: William R. McCulloch, Broomfield, CO (US); Craig J. Lund, Louisville, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: CARETOUCH COMMUNICATIONS, INC., Boulder, CO (US)

(21) Appl. No.: 11/065,593

(22) Filed: Feb. 23, 2005

Related U.S. Application Data
(60) Provisional application No. 60/547,115, filed on Feb. 24, 2004.
(60) Provisional application No. 60/547,264, filed on Feb. 24, 2004.

(51) Int. Cl. G06F 17/60; G08B 23/00

(52) U.S. Cl. 340/500; 705/2

(57) ABSTRACT

A method for delivering a long term care message to a recipient includes gathering long term care information from a records repository and encoding at least some of the long term care information into predefined codes associated with predefined script segments. A script is generated using the script segments, and a human-understandable message is delivered to the recipient. A system for delivering a message related to long term care of a client serviced by an assisted living service provider includes an administration user interface enabling definition of script components that can be used to describe long term care of the client. A user associated with the assisted living service provider can record long term care information about the client. A script is generated using selected script components associated with the long term care information. A distributor module causes the script to be converted into a human-understandable message that is delivered to a message recipient.

### RELATED APPLICATIONS

This application claims benefit of U.S. Provisional Application No. 60/547,115, filed Feb. 24, 2004, entitled “Communication of Health Status Information,” and U.S. Provisional Application No. 60/547,264, filed Feb. 24, 2004, entitled “Automated Distribution of Custom Messages Pertaining to the Birth of a Child,” which are incorporated herein by reference for all that they disclose.

### BACKGROUND

Long term care facilities, such as nursing care facilities or assisted living facilities, provide day-to-day care for millions of people. In the United States alone it is expected that nursing homes will offer long term care to over 3.5 million nursing home residents in 2004. This clearly will increase as the average age of the population increases. As part of the living environment, long term care facilities typically provide health care, such as rehabilitative care, Dementia care, hospice services as well as entertainment or activities for the residents. Unfortunately, when a person is admitted to a long term care facility, it becomes difficult for family and friends of the person to keep informed about the person's health and day-to-day activities. Practical, business, and legal obstacles often stand in the way of communicating valuable information to friends and family.

Because of demands involved with operating a nursing care facility, it is difficult for many nursing care facilities to keep nursing care facility residents' family and friends informed about the residents. Clinicians and staff at the nursing care facility typically spend most of their time tending to the needs of the residents. Therefore, nursing care facility staff typically do not have time to notify all the family and friends of residents about the resident. Because labor is typically the largest operating expense for nursing care facilities, most nursing care facilities do not hire a full time employee to regularly provide information about the residents to their family and friends.

In addition, communications difficulties are compounded by busy lifestyles of friends and family who are geographically dispersed. Consequently, a convenient time to call for the interested party is not necessarily a convenient time for the resident and vice versa. Unfortunately, often the family or friends of the resident only receive information when a health emergency has arisen.

Furthermore, privacy rules mandated by the Health Insurance Portability Accountability Act of 1996 (HIPAA) place additional burdens on health care providers and nursing care facilities to regulate access to patient health information. Therefore, it is incumbent upon nursing care facilities to secure authorization prior to releasing private information.

Yet another problem related to communication of long term care information relates to the ability of the family or friends to understand the technical terms and medical lingo often used in the long term care industry. The family members and friends are typically not experts in the field of medicine or long term care. Indeed, family and friends are typically laypersons without specialized knowledge. Unfortunately, clinicians and other health care providers at long term care facilities find it difficult to relate information in a nontechnical way. Family and friends are often frustrated with the highly technical medical jargon that they receive.

### SUMMARY

Embodiments of systems and methods described herein provide for automatically gathering and disseminating information related to long term care of a client of an assisted living service provider. The information can be delivered in the form of a human-understandable message, which can be audible, text, or another format. The human-understandable message can be generated based on a script that is built from predefined script segments associated with long term care information provided by the assisted living service provider.

A system for delivering a message related to long term care of a client serviced by an assisted living service provider includes an administration user interface enabling definition of script components that can be used to describe long term care of the client. A message builder user interface enables a user associated with the assisted living service provider to record long term care information about the client, and generates a script using selected script components associated with the long term care information. A distributor module causes the script to be converted into a human-understandable message that is delivered to a message recipient.

A method for delivering a long term care message to a recipient includes gathering long term care information from an assisted living service provider and encoding at least some of the long term care information into predefined codes associated with predefined script segments. A script is generated using the script segments, and a human-understandable message is generated from the script and delivered to the recipient according to a schedule.

A more complete understanding of the present invention may be derived by referring to the detailed description of preferred embodiments and claims when considered in connection with the figures.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary operating environment in which an embodiment of a long term care notification service and an intelligent message delivery system can operate;

FIG. 2 is a block diagram illustrating functional modules and data structures in an exemplary embodiment of the long term care notification system;

FIGS. 3-6 illustrate exemplary screen shots of user interfaces provided by a long term care notification service and used for gathering long term care information from an assisted living service provider;

FIG. 7 is a block diagram illustrating functional modules and data structures in an exemplary embodiment of the intelligent message delivery system in conjunction with the long term care notification service;

FIG. 8 illustrates an embodiment of a message building scheme that may be carried out by the message builder of the intelligent message delivery system;

FIGS. 9 illustrates an exemplary scenario showing an exemplary message that might be received by the message builder and an exemplary script that might be generated for use in creating a human-understandable message;

FIG. 10-32 illustrate algorithms that can be carried out by embodiments of long term care notification systems and/or intelligent message delivery systems described herein; and

FIG. 33 illustrates is an exemplary computing device with which embodiments of the present invention may be implemented.

### DETAILED DESCRIPTION

Broadly stated, embodiments of the present invention can provide a flexible and secure communications infrastructure that can support the needs of various computer telephony and web-based message delivery systems for communicating information related to long term care of an individual. Embodiments include a communication platform that receives long term care information from assisted living service providers. A flexible communications platform architecture is employed to generate messages based on the long term care information.

The terms ‘long term care information’ and ‘long term care data’ refer to any data related to the care of a client provided by an assisted living service provider. Long term care (LTC) information can include, but is not limited to health status, activities of daily living (ADL), adverse events, medications, assisted living service provider general information, special dates associated with the client, and personal needs of the client.

‘Assisted living service providers’ include any entity that provides assisted living care to a client. Thus, assisted living service providers include, but are not limited to, nursing care facilities, long term care facilities, assisted living facilities, continuing care retirement communities, group homes, and at-home caregivers. Assisted living service providers can also included contracted durable goods providers, such as home oxygen vendor.

The terms ‘provider’ and ‘service provider’ are used interchangeably to refer to a ‘assisted living service provider.’ A ‘client’ is any person who receives long term care from an assisted living service provider. A client can be a resident of an assisted living service provider, or the client can live at home with the help of an at-home caregiver.

In accordance with some embodiments, assisted living service providers enter LTC data related to a client. The LTC data is captured by a notification service, which can format the LTC data in a manner that facilitates incorporation into a message. The LTC data may be entered via a user interface provided by the notification service. Alternatively, the LTC data may be entered into a records database at the assisted living service provider, and accessed by the notification service through a direct interface to the records database. This accessibility of the direct interface may be implemented as a “push” or “pull” process. Direct access to the service providers' servers may be employed or an interim staging area may be populated by the service provider, which would be accessed by the notification service. Alternatively, the service providers may create a process that generates the LTC data and pushes it to the notification service. The format of the LTC data may be of any type (e.g. comma delimited file, XML, unknown format with the header defining the structure, or the like ).

Some embodiments include a message delivery system, which receives a message including codes related to a client for delivery to a targeted recipient. A human-understandable message is generated using a script component data structure that defines translations between codes and script segments. A script component data structure can be extensible and can include application product-specific script components. Another script component data source can include industry-specific script components. Application product-specific script components can be created, edited, and expired by a notification service that can provide notification application products for the recipient. The message delivery system can choose from available script templates to facilitate freshness of messages that are delivered to the target.

According to one embodiment the communications infrastructure may support many different subscription services offerings, such as message delivery systems having a primary account and associated members (e.g., a predefined distribution community to which customized messages are to be delivered).

In accordance with one embodiment, the script component data source can include multiple script components having a common meaning wherein each of the multiple script components expresses the common meaning in a different style. One of the multiple script-components is selected for inclusion in a message when a script template is created.

In some embodiments, message freshness is preserved by delivering human-understandable messages in a substantially non-repetitive order. In accordance with one embodiment, a previously unsent script template is selected at random to generate the human-understandable message for delivery. In accordance with this and other embodiments, when all the available script templates have been used, the least recently delivered script template is selected to generate the human-understandable message. Delivery of the message can be logged with time and date of delivery.

In accordance with a particular embodiment, the human-understandable message is delivered in audio format. In this embodiment, the human-understandable message is composed of tag data readable by a text-to-speech (TTS) system, which converts the script into an audio message. The audio message is delivered to the target via an audio output device, such as a computer speaker or telephone. According to some embodiments, a subscriber can retrieve a human-understandable message from the intelligent message delivery system. In these embodiments, the subscriber can call a specified phone number and, after authentication, receive the human-understandable message in an audible form.

In accordance with some embodiments, the human-understandable message is delivered securely. According to these embodiments, the identity of the target recipient can be verified prior to delivery of the human-understandable message. Verification may include verification of biometric data. Verification can also include verification of private information from the target. Verification may include verification of a smartcard. Verification can also involve use of a public key infrastructure (PKI) to verify the target and/or the intelligent message delivery system.

According to one embodiment, an intelligent message delivery system (IMDS) is a core software engine providing services that allow for inbound subscriber transactions and produce outbound subscriber specific information based on the subscriber's profile. The IMDS is capable of defining a top level application product (such as a baby notification system, health care status messaging system, long term care notification system, or a health care education system), accepting information from this product, creating messages based on the application's profile elements, and delivering the messages on behalf of the application.

The term “human-understandable” refers to the ability of a human to readily perceive the meaning of something (e.g., a script or message). Thus, generally codes are not human-understandable because codes do not mean anything to a human until they are translated or converted into a form that can be understood by a human. A human-understandable message contains meaningful information about a client. In certain embodiments, a human-understandable message includes readable text in a format commonly understood by a recipient of the message. In other embodiments, a human-understandable message includes audible statements including words and phrases that would commonly be understood by a recipient. Thus, a human-understandable message can be embodied in a variety of formats including, but not limited to, an audio file (e.g., .wav, .mp3., .au), a text file (e.g., an email message, a web page), a audio/video file (e.g., .ram, avi), or others.

A “message” generally refers to the content of a communication transmitted by electronic means, such as an email message, telephone or other audio channels, a paging network, radio, or the like to the distribution community.

A “script” generally refers to one or more associated script segments and/or one or more data elements. A script may be represented by a data structure that links related script segments together with data elements. A script may also be represented by concatenated, aggregated, or otherwise combined or processed script segments.

A “script component” is an association between at least a script component identifier and a script segment. The script component may also include a segment name, value, or other information.

A “script segment” generally refers to information that can be readily converted into speech or text representing a human-understandable word, phrase or statement. One or more script segments joined with one or more data elements when concatenated together form a script. According to one embodiment, a script segment may be represented as a snippet of text (e.g., one or more words stored as text strings). Alternatively, script segments may be retrieved from a relational database or derived from informational content of a relational database (e.g., numeric values, text strings, and/or enumerated values). According to one embodiment, script segments may be stored in native speech format, such as .wav files representing pre-recorded speech samples or pre-synthesized words, phrases or statements.

The term “target” generally refers to a subscriber or member of a distribution community to whom a message or script is to be delivered. A “recipient” is generally one who receives a message or script or for whom a message or script is intended.

In the following description, for the purposes of explanation, numerous specific details regarding an existing commercial embodiment are set forth in order to provide a thorough understanding of the present invention. It will be apparent, however, to one skilled in the art that the present invention may be practiced without some of these specific details. In other instances, well-known structures and devices are shown in block diagram form.

Exemplary System and Architecture

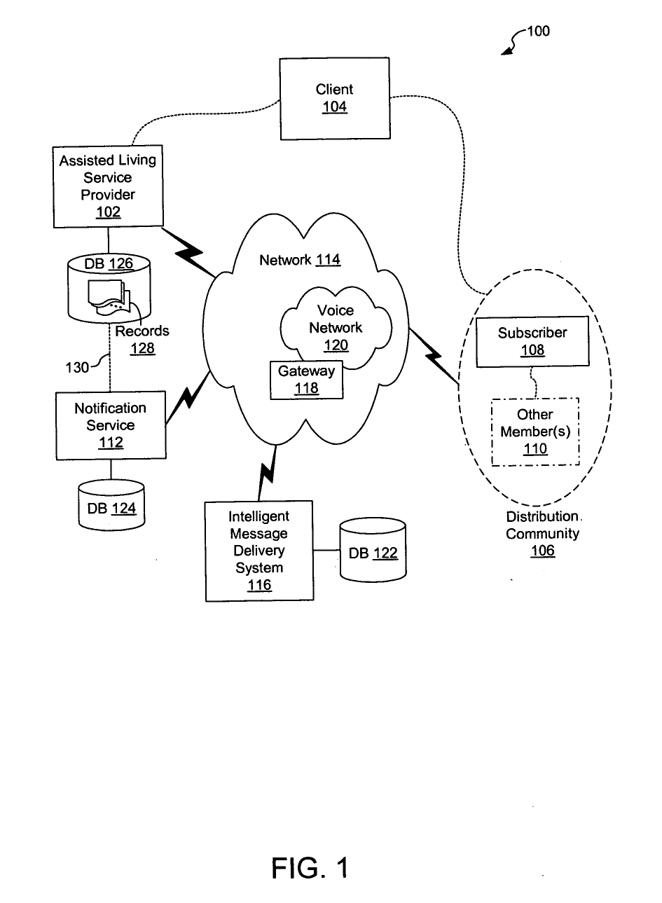

FIG. 1 illustrates an exemplary operating environment 100 in accordance with one embodiment of the present invention. Generally, an assisted living service provider 102 provides long term care to a client 104. The long term care can include providing health services, activities, food, medicine, clothing, and the like. Certain third party individuals may want to keep apprised of the long term care of the client 104. For example, the third parties may want to be regularly informed about the health status of the client 104, or the daily activities participated in by the client 104. Third parties who might be interested in the client 104 include, but are not limited to, friends and family of the client 104.

Assisted living service provider 102 is representative of many types of care providers. For example, the assisted living service provider 102 may be a long term care facility, such as a nursing home facility, assisted living facility, continuing care retirement community, or group home that provides care to residents of the facility. Alternatively, the assisted living service provider 102 could be an at-home service provider or caregiver, who visits the client 104 at the client's home. Regardless of the particular type of care provider, the assisted living service provider 102 documents or records information related to the long term care of the client 104. The long term care information can be distributed to interested and authorized third parties.

Third parties are generally represented by a distribution community 106. The distribution community 106 includes one or more members, such as a subscriber 108 and/or other members 110, to whom long term care information is to be distributed. The subscriber 108 represents a primary person within the distribution community who registers to receive the long term care information. The other members 110 represent secondary people who can also be registered to receive long term care information. As will be discussed below, in one embodiment, the other members 110 can be included as secondary members on an account of the subscriber 108, which enables the members 110 to receive the long term care information.

The subscriber 108 registers with a long term care notification service 112, which can provide the long term care information to the distribution community 106. The long term care notification service 112 communicates with the assisted living service provider 102 via a network 114. In general, the long term care notification service 112 gathers long term care information from the assisted living service provider 102. The long term care information is then used to generate a long term care message for delivery to the distribution community 106.

The assisted living service provider 102 generally employs staff, such as clinicians, nurses, dieticians, or caregivers who visit the client(s) 104. Workers associated with the assisted living service provider 102 are generally referred to as ‘staff’, whether they are clinicians, caregivers, or others. The visits to the client(s) 104 may be scheduled appointments and/or informal visits, or even observations that the staff makes in various settings. Typically the staff generates reports that include the information gathered about the client(s) 104. These reports and their content are generally referred to as long term care (LTC) information.

The LTC information may be gathered by the notification service 112 using a “push” or “pull” mechanism. In addition, the LTC information may be gathered on a scheduled basis or be event-driven. For example, in one embodiment, the LTC notification service 112 downloads the LTC information from a records database 126 in communication with the assisted living service provider 102 on a regular basis (e.g., weekly) using a direct interface 130. The records 128 can include clinical as well as social data, regular activities, scheduled activities, special events, and calendar data. An example could be an indicator that a client 104 plays bingo every Wednesday. The records 128 in the records database 126 can be in a format specified by a third party vendor-provided record system, such as MCKESSON, ADL DATA SYSTEMS, KEANE, or the like.

The LTC notification service 112 can download the LTC information for all the clients 104 being serviced by the assisted living service provider 102. Download can be in a batch mode, realtime or otherwise. Prior to download, the long term care notification service 112 can remind staff of the assisted living service provider 102 to enter the LTC information prior to the scheduled download. The reminder can be in the form of an email message sent to the staff, or another notification mechanism.

In another embodiment, the assisted living service provider 102 uploads the LTC information to a database 124 at the long term care notification service 112. This can be done on a scheduled basis, such as according to the staff person's schedule. Alternatively, the LTC information can be uploaded after the staff person meets with the client 104. If staff at the assisted living service provider 102 forget to enter LTC information, the long term care notification service 112 can remind the staff with an email message or other notification. In this embodiment, staff at the assisted living service provider 102 accesses a message building user interface (discussed further below) that enables the staff to enter LTC information for use in generating a message to be delivered to the distribution community 106.

At some time after the LTC information is gathered or while it is being gathered, the LTC notification service 112 employs an intelligent message delivery system (IMDS) 116 to create and deliver the long term care message. In the embodiment shown, the long term care notification service 112 and the IMDS 116 are implemented on separate devices, and communicate via the network 114. In other embodiments, the IMDS 116 and the LTC notification service 112 can be embodied on the same device, and even as a single, integrated system.

The IMDS 116 causes a human-understandable message to be delivered to one or more members of the distribution community 106 via the network 114. In one embodiment, the IMDS 116 creates a script using the long term care information. The script is then used to generate the human-understandable message. The human-understandable message can be delivered in any of a number of formats including text or audio, or a combination of text or audio.

Audio formats can be delivered telephonically. In one embodiment, the IMDS 116 delivers a script to a voice gateway 118, which converts the script to an audible format that can be sent to the distribution community 106 via a voice network 120. The voice network 120 represents a voice over Internet protocol (VOIP) network, and may be connected to a public switched telephone network (PSTN) (not shown) to enable communication with the distribution community 106. The gateway 118 can include a voice web server, voice verification engine, speech recognition engine, a text-to-speech engine, or other technologies. The gateway 118 uses text-to-speech (TTS) technology to convert the script to a human-understandable audio message, and issues a call to the phone of the subscriber 108 (or other member 110), whereby the message can be played to the recipient over the phone.

The IMDS 116 can cause the human-understandable message to be delivered in a secure or non-secure fashion. In one secure embodiment, the IMDS 116 transmits an email message to member(s) 106 via the network 114. In this embodiment, the human-understandable message can be stored on a server that is accessible to the distribution community 106. The human-understandable message can include text and/or audio, such as ‘.wav’ or ‘.mp 3’ formats. The email message can contain a hyperlink to the server containing the human-understandable message. When the hyperlink is selected, the recipient is directed to a secure login webpage, through which the recipient logs in prior to viewing the message. Such a login could include entering a user name and password. Secure delivery via the network 114 may also involve use of a public key infrastructure (PKI) (not shown).

In another secure embodiment, the IMDS 116 utilizes biometric verification. Biometric verification can include fingerprint verification, iris verification, voice verification, and others. Using biometric verification, the human-understandable message is not delivered unless the recipient is confirmed to be an authorized recipient. In these embodiments, it is assumed that the message recipient to be verified has access to a biometric input device (e.g., a sensor or scanner) that enables the recipient to input the appropriate biometric information. For example, using voice verification, the recipient speaks into an audio receiver (e.g., microphone or telephone receiver). When fingerprint verification is used, the recipient applies his finger to a fingerprint scanner. When iris verification is used, the recipient looks into an iris scanner. Regardless of the type of biometric verification, the biometric data that is captured from the recipient is encoded into digital data that can be compared to a previously captured biometric print associated with an authorized member.

In another embodiment, the IMDS 116 causes the recipient of the message to be verified using a pin number or other password. In this embodiment, the message can be delivered via telephone and the speaker who answers the call is verified using pin number that the speaker enters using alphanumeric keys on the telephone. Dual tone modulation frequency (DTMF) can be used by the voice gateway 118 to identify alphanumeric entry by the speaker. Based on the alphanumeric entry, the IMDS 116 determines whether the speaker is authorized based on a predefined password or pin number.

For example, in an embodiment utilizing voice verification, the IMDS 116 can employ the voice network 120. The IMDS 116 transmits the script and member(s) 110 contact information (e.g., a phone number) to a voice gateway 118. The voice gateway 118 includes text-to-speech (TTS) capability and can convert the script into an audio message. The voice gateway 118 calls the target member(s) 110 via the voice network 120. When the call is answered, the voice gateway 118 accepts input from the speaker via an automated speech recognition system, and verifies whether the voice of the speaker who has answered the call matches a voice print of the authorized member(s) 110 who is/are intended to receive the audio message.

For convenience, FIG. 1 illustrates one assisted living service provider 102, one client 104, and one distribution community 106. However, it will be understood that in general, there can exist multiple service providers 102, multiple clients 104 per service provider 102, and multiple distribution communities 106. Typically, the LTC notification service 112 provides services for multiple distribution communities 106 with respect to multiple assisted living service providers 102. As is discussed in detail below, the IMDS 116 includes scalable features that enable intelligently processing and delivering messages related to many different clients 104 from many different notification services 112 and/or service providers 102 to many different distribution communities 106. Indeed, the IMDS 116 is scalable to be able to handle messages related to many different industries, application products, and environments.

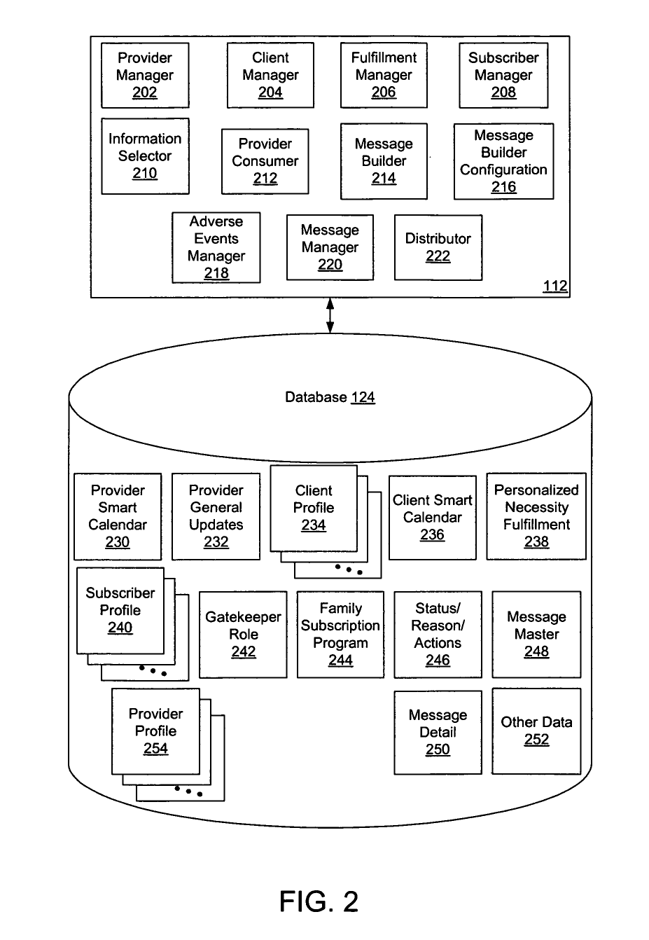

Subscribers 108 register with the long term care notification service 112 in order to use services or application products offered by the long term care notification service 112. When registering, the subscriber 116 specifies information about himself, the distribution community 106 and the desired service. For example, the subscriber can specify one or more of the subscriber, the client 104, service level, preferred time(s) to be notified, payment information (e.g., credit card), relationship to the client 104, member(s) 110 in the distribution community 106, and other data. The information is stored in a subscriber profile (e.g., subscriber profile 240, FIG. 2), described in detail below. Profile information for other members who are not subscribers may also be included in the associated subscriber's profile.

In one embodiment the LTC notification service 112 offers application products to provide services related to notification of the distribution community 106, service provider 102, or others, of relevant information. Some application products compile LTC information from the assisted living service provider 102 and generate a series of corresponding codes and/or data elements. The LTC notification service 112 sends the series of codes and/or data elements to the IMDS 116, which builds a human-understandable message based on the codes and/or data elements and causes the message to be sent to a specified recipient in the distribution community 106.

In another embodiment, the notification service 112 provides an application product that communicates responses from a recipient in the distribution community to the service provider 102. In another embodiment, the application product handles requests from the recipient. For example, in the case of an assisted living environment, the recipient may request that an item be purchased for the client 110 (in this case a resident of the assisted living facility). In response, the notification service 112 can order the item and have the item delivered to the service provider 102 (in this case, the assisted living facility). The requested item may be ordered from an on-line retailer via the network 114.

Although the embodiments discussed below relate to an assisted living environment (e.g., a nursing care facility), based on the embodiments described herein, those skilled in the art will readily recognize how to adapt the embodiments to other environments. The applications offered by the notification service 112 and the information provided by the applications typically depend upon the client 104. For example, when the client 104 is a resident of an assisted living care facility, the application will typically offer information related to the resident's long term care (e.g., health, activities, events, etc.).

In one embodiment, application products provided by the notification service 112 provide an user interface (e.g., a web interface) to the service provider 102. A user at the service provider 102 accesses the user interface to record data related to the client 104 and/or configure categories of LTC information that can be recorded and captured. For example, a clinician (the user) may enter data related to health status of a resident. The user interface can be designed to facilitate the data entry by presenting a standard set of questions or prompts. Using the user interface, the user records health status information. The application gathers the user's responses to the questions or prompts. In one embodiment, the data entered by the user is associated with predefined codes that correspond to predefined script segments, which can include human-understandable text expressing the meaning of the data.

In one embodiment, messages are sent to subscribers 108 on a regularly scheduled basis (e.g., once per week). The timing of messages is based on the subscriber's 108 specified preferred time to receive messages. Thus, the schedule can vary from one subscriber 108 to another. Because messages are delivered according to a schedule, the notification service 112 periodically obtains application message data from the service provider 102. The application message data may be obtained using a “push” mechanism (e.g., the service provider 102 sends it to the notification service), or by a “pull” mechanism (e.g., the notification service retrieves the data from the service provider 102). To facilitate delivery of the messages to the subscriber 108, the notification service 112 uses the IMDS 116. Advantageously, the IMDS 116 can use the application message data to build messages that are substantially different each time a message is sent to the subscriber 108, so that messages are fresh to the subscriber 108.

In one embodiment, each notification service 112 registers with the IMDS 116 to employ the IMDS 116 to deliver messages on behalf of the notification service 112. Registration may be facilitated via the network 114, whereby the IMDS 116 provides an interface through which notification service 112 can register. The IMDS 116 provides flexibility in the manner and format of communication to the distribution community 108. For example, the IMDS 116 can provide a basic set of script components, but can also allow each notification service 112 to define its own set of script components or build upon the basic set.

Script components defined by each notification service 112 can be application product-specific (e.g., related to long term care information or other information). In addition, the IMDS 116 can provide sets of industry-specific script components, which can be selected by each notification service 112. Thus, although the embodiments of the IMDS 116 shown herein are directed to the long term care industry, they are not limited to the LTC industry and can serve many different types of application products from notification services 112 in many different fields and industries.

FIG. 2 is a block diagram illustrating exemplary functional modules and data structures in a particular embodiment of a long term care (LTC) notification service 112. The various functional modules and data structures shown can be implemented in hardware, software, firmware, or any combination of thereof. Generally, the modules include or are embodied in interfaces that enable the modules to communicate with each other, as well as to external systems that communicate with the LTC notification service 112. The modules in the notification service 112 can change data in the database 124 in response to user or system input.

A provider manager 202 performs functions related to managing information associated with registered assisted living service providers. For example, using the provider manager 202, personnel at the notification service 112 and/or assisted living service provider 102 staff can manage provider profile 254 information, administer assisted living service provider smart calendars 230, and create messages for general distribution.

In one embodiment the provider smart calendar 230 includes a smart calendar function that enables assisted living service provider staff to document upcoming activities, which can be integrated into messages that are delivered to a subscriber or other members of a distribution community. Possible activities can include events associated with non-religious holidays, international holidays, and religious holidays. Provider smart calendar 230 can also provide the ability to query the subscriber base for events that the subscribers may participate in, allowing the service provider to capacity plan for such events. For example, subscribers can be prompted to RSVP (i.e., please reply) for events such as Thanksgiving dinner.

Assisted living service provider general updates 232 include information that relates generally to the assisted living service provider and not to a particular client or resident of the assisted living service provider. For example, general updates 232 can pertain to extra flu shots, staff member vacations, and construction update. The general updates 232 can be broadcast to all subscribers.

A client manager 204 performs functions related to management of client profiles 234. In one embodiment, the client manager 204 provides a secure HTTP web interface, through which an assisted living service provider staff person can create, update, edit, and delete client profiles 234. Each client profile 234 includes client attribute information for a corresponding client. Examples of client attribute information include name, primary contact, age, birthday, religious affiliation, height, weight, clothing size, and color preference. Additional client attribute information may be included.

A client smart calendar 236 stores dates of events that can be documented by assisted living service provider staff. Through the client manager, assisted living service provider staff can create, delete, or edit events within the client smart calendar 236 for individual clients. In addition, in some embodiments, the client smart calendar 236 has functionality that automatically identifies client specific events, such as, but not limited to, client's birthday, religious holidays. Other events that can be created by the staff include off- site medical visits.

Personalized necessity fulfillment data 238 includes data related to items that the client needs. Through the client manager 204, assisted living service provider staff can specify items that are needed by a client. In one embodiment of the client manager 204, needed items can be selected from a list of available items and selected items are then identified in the personalized necessity fulfillment data 238. Later, as is discussed further below in more detail, a subscriber can be notified of the needed item in a message and prompted to purchase the item for the client. A fulfillment manager 206 can then cause the item to be ordered and delivered to the client on behalf of the subscriber.

The fulfillment manager 206 manages the fulfillment of purchases by subscribers for client. When a subscriber wishes to purchase an item for a client, the fulfillment manager 206 can order the item and arrange delivery of the item to the assisted living service provider on behalf of the subscriber. The fulfillment manager 206 can order the item from an online retailer. The fulfillment manager 206 then monitors the transaction, and signals the message builder utility 214. The message builder utility 214 indicates to appropriate assisted living service provider staff that a needed item was ordered, and allows the staff to indicate whether and/or when the item has arrived. The subscriber can receive a receipt, via a subsequent message, verifying the item was received. The notification service can contract with affiliate providers to acquire desired items for the clients.

In one embodiment, personal necessities identified in the personalized necessity fulfillment 238 can be merged with scripts generated by the IMDS. The human-understandable message that is sent to the subscriber (or other member) can include an offer for the subscriber to purchase the needed item for the client. When the subscriber authorizes a purchase, the fulfillment manager 206 orders the item through a contracted affiliate to provision the item, and ship it to the assisted living service provider for the client. Upon receiving the item, the assisted living service provider staff indicates, via the client manager 204, that the item has been received, triggering a receipt confirmation back to the subscriber.

A subscriber manager 208 performs tasks related to management of subscriber accounts. In one embodiment, the subscriber manager 208 enables assisted living service provider staff to create and manage subscriber profiles 240. In some embodiments, subscribers can be granted access to their account for management of their subscriber profile 240 via a web or telephony interface. In Internet-based profile management, creating and editing the subscriber profiles 240 is typically performed via a secure Hypertext Transfer Protocol (HTTP) web interface. Subscriber profiles 240 can include one or more of name, address, contact information (may be multiple), service level, contact source and time, and payment information (e.g., credit card number), other members in the distribution community, categories of LTC data that the subscribers want to be provided, and other data.

Because clients may have multiple subscribers receiving health messages for them, a subscriber may be designated as a “gate keeper” 242. The gate keeper has authority to control aspects of message content and message delivery to members of the client's distribution community. In one embodiment, the gate keeper 242 defines the level of information the other members may receive.

Family subscription programs 244 enable a group of subscribers or members to purchase a single subscription for multiple subscribers (e.g., a family related to the client). In one embodiment, there is a single subscriber within the group that is accountable for payment for the group. This key person is also designated the gate keeper 242 within their family program 244.

An information selector 210 enables subscribers to specify the amount and/or types of information to be included in messages they receive. In one embodiment, the information selector 210 is embodied in a user interface through which each member of the distribution community can select the amount and/or types of information that makes up each member's messages. This selection can be modified at any time, and as many times, per each members discretion. The amount and types of information that a member can select from can be constrained by the gate keeper 242 of the distribution community. For example, the gate keeper 242 can limit the amount and types of information each member in the distribution community can receive.

A provider consumer 212 performs tasks related to data entry by the assisted living service provider. In one embodiment, the provider consumer 212 presents a user interface through which the assisted living service provider staff can record LTC information for assigned clients. In another embodiment, direct clinical system interfaces can directly access the records database of the assisted living service provider. Direct interfaces consume defined clinical data. The clinical data and LTC information from both types of interfaces can be used to populate message builder sessions.

A message builder utility 214 provides a message builder user interface through which provider staff can record LTC information about clients. The message builder utility 214 then creates messages using the data that is entered by provider staff. In one embodiment, the message builder includes a graphical user interface over the Internet that allows provider staff to record LTC information about clients. These LTC data records are captured prior to message creation. In some embodiments, the message builder utility 214 is operable to integrate data collected from defined direct interfaces to providers' clinical charting systems. Exemplary user interfaces are discussed in further detail below.

A message builder administration module 216 performs functions related to administering and/or configuring data types that can be used in messages during message building sessions. In one embodiment, the administration module 216 provides an administration user interface that enables staff of the assisted living service provider to designate the types of LTC information that can be recorded about clients. In this regard, the administration module 216 allows assisted living service providers to configure the message builder 214 including specifying categories and subcategories of information is to be recorded. Message builder 214 sessions can have categories, elements, sub-elements, values and translation, discussed in further detail below. The definitions can be created and published by administrators of the assisted living service providers.

An adverse events manager 218 performs functions related to adverse events specified by a regulatory body. The adverse events manager 218 manages the requirements associated in the reporting of an adverse event according to governmental regulations, which require reporting certain events at specified times, including specified data, and/or in specified formats. For example, state governments often stipulate the time and process of reporting adverse events. Pre-defined events are configured within the system to be used when an adverse event occurs. Provider staff initiates the adverse event reporting process, which executes governmental reporting, and defined escalation notification, i.e. facility administrator, lead clinician.

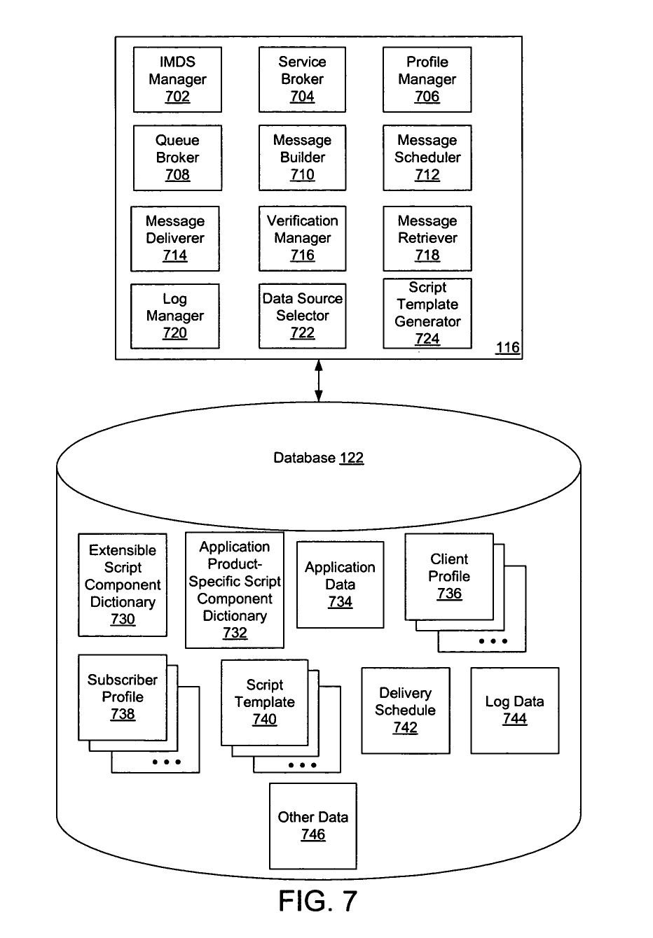

A message manager 220 performs functions related to generating messages for the distribution community. Generally, the message manager 220 compiles all elements of the message to be distributed to subscribers. In one embodiment, the message manager 220 can be an extension of the IMDS sub-system message builder (message builder 710, FIG. 7, described below), to ensure appropriate components are included within the message. Assembly components of the message can include one or more of health status, surveys, personalized necessity fulfillment, activities of daily living (ADL), special dates, and other information.

In one embodiment, other information that can be recorded by provider staff includes reasons and actions 246. Actions refer to actions taken by the assisted living service provider (or staff) with respect to a client. Reasons refer to the reason why the assisted living service provider (or staff) took a certain action or reasons for the message. Reasons and actions are associated with a status and provide further clarification for the subscribers about clients. The reasons and actions can be merged with other LTC information when generating messages to be delivered to the distribution community.

A distributor module 222 monitors the consumption of assisted living service provider client long term care data, either by the message builder 214 or direct provider interfaces. The distributor 222 can manage when certain LTC data should be gathered and sent to the IMDS. The distributor 222 may also communicate with the IMDS deliverer (discussed below) to facilitate delivery of messages at appropriate times.

As discussed above, in some embodiments, long term care information can be gathered by the notification service 112 via direct interfaces to records at the assisted living service provider. In other embodiments, staff at the assisted living service provider 102 enters LTC information into interfaces provided by the LTC notification service 112. In some embodiments, both types of interfaces are used. For example, the direct interface can be used to gather LTC data of a certain type (e.g., vendor provided clinical record systems), while user interfaces are used to gather information of other types.

In one embodiment, when the message builder 214 gathers data to build a message, two data structures are created based on the LTC data from the assisted living service provider 102. The two data structures are message master 248 and message detail 250. Generally, message master 248 and message detail 250 define contents of a message using predefined script components. Illustrative examples of message master and message detail data structures are shown and described below. Other data 252 includes any other data required by the notification service 112.

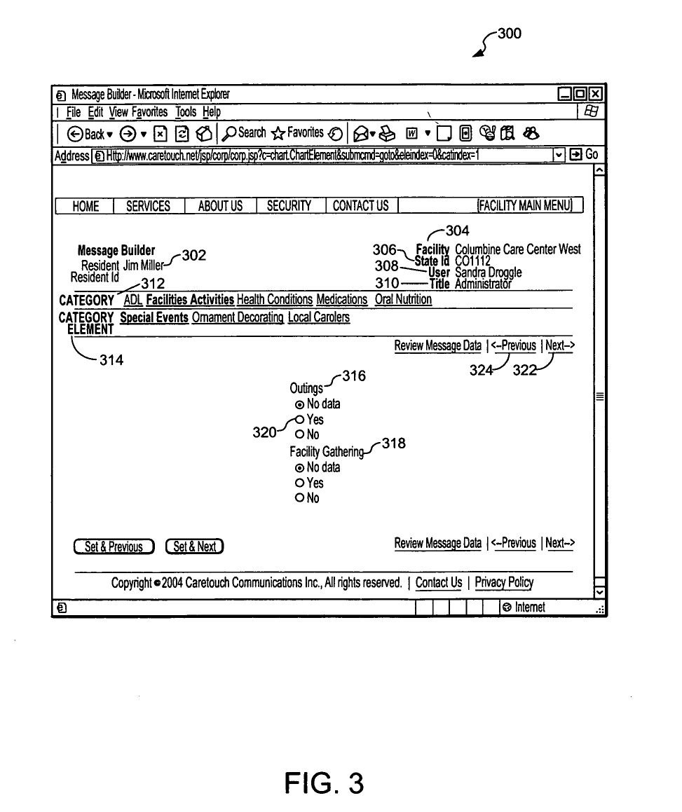

FIGS. 3-6 illustrate exemplary screen shots of user interfaces to the LTC information notification service 112. Using the interfaces shown in FIGS. 3-6, staff associated with an assisted living service provider 102 can enter long term care information related to clients 104 and/or the assisted living service provider 102. The exemplary user interfaces are shown as web pages that can be accessed by an Internet browser such as INTERNET EXPLORER from MICROSOFT CORPORATION or NETSCAPE NAVIGATOR from NETSCAPE.

User interfaces are not limited to those shown in FIGS. 3-6. Other user interfaces will generally be available to enter other types of LTC information. In addition, although the embodiments of user interfaces shown in FIGS. 3-6 are graphical user interfaces (GUI), it is to be understood that user interfaces are not limited to graphical user interfaces.

In one embodiment, the user interfaces are accessed in a message builder session. During a message builder session, the user enters, views, and edits long term care data by accessing different user interfaces. While the data is entered, the message builder of the notification service captures the data and puts the data into a form that can be used by the IMDS. The IMDS then generates a human-understandable message for delivery to the distribution community. The IMDS is discussed in further detail below. The initial steps in creating a message are included in the message builder session, illustrated by way of the user interfaces shown in FIGS. 3-6.

FIG. 3 illustrates a screen shot of a user interface 300 through which provider staff can enter information related to gatherings and/or outings, and can also change to other pages to enter other types of long term care information. In this case, the term ‘facility’ refers to a provider, such as a nursing care facility. LTC data is entered for the client, identified by client name 302. The facility and staff are identified by facility name 304, state identifier 306, user name 308 and user's job title 310.

Categories of LTC care information are listed in a category menu 312. A category of LTC care information generally refers to a class of LTC elements or sub-elements of similar characteristics. An LTC element generally refers to a subcategory of LTC data associated with a category. A sub-element generally refers to a subcategory of data associated with an element. Typically, elements and sub-elements can have values associated with them. The values are used to characterize the long term care of a client. Embodiments of the user interface 300 can be used by assisted living service provider staff to set the values associated with categories, elements, and sub-elements for a client. Later, the selected values can be used to create a script and a human-understandable message.

Continuing with the example of FIG. 3, exemplary categories shown therein include ‘activities of daily living’ (ADL), ‘facilities activities’, ‘health conditions’, ‘medications’, and ‘oral nutrition’. In this example, the category ‘facilities activities’ is selected (shown by bold print). A category element menu 314 lists exemplary category elements associated with the selected category. In this case, category elements available for facilities activities include ‘special events’, ‘ornament decorating’, and ‘local carolers’. In this case, category element ‘special events’ has been selected (shown by bold print).

As discussed above, for each category element, there can be associated sub-elements. Each sub-element can take on a value. For example, category element ‘special events’ includes sub-elements ‘Outings’ 316, and ‘Facility Gathering’ 318. The sub-element ‘Outings’ 316 can take on one of the values ‘No data’, ‘Yes’, or ‘No’. Sub-element ‘Facility Gatherings’ can take on one of the values ‘No data’, ‘Yes’, and ‘No’. In the particular embodiment shown, the user (e.g., staff) can select the appropriate sub-element value by clicking a corresponding radio button 320. The user can advance to another page of sub-elements by selecting ‘Next’ hyperlink 322 or go back to a previous page of sub-elements by selecting a ‘Previous’ hyperlink 324. Categories, elements, and sub-elements are not limited to those shown in FIG. 3.

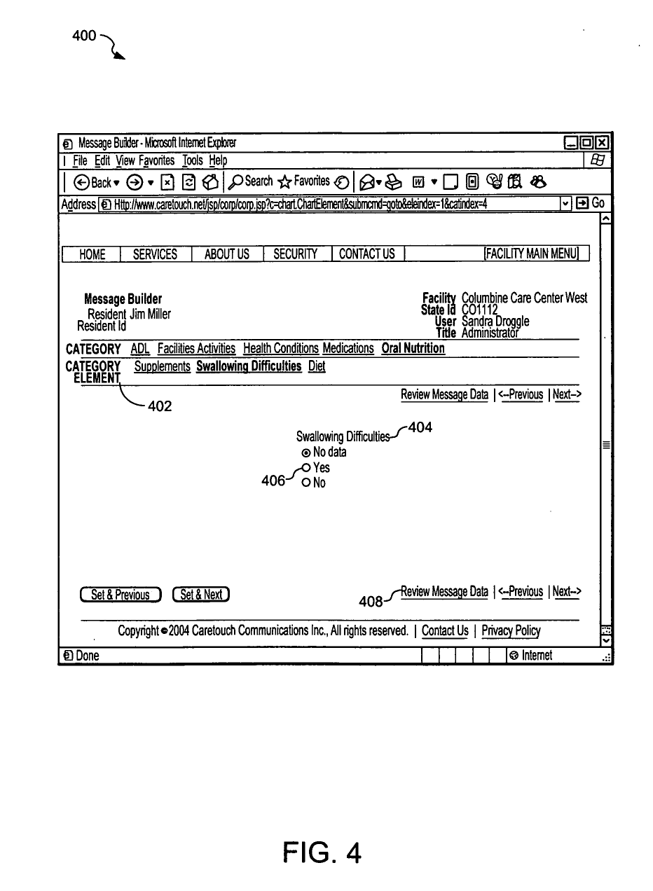

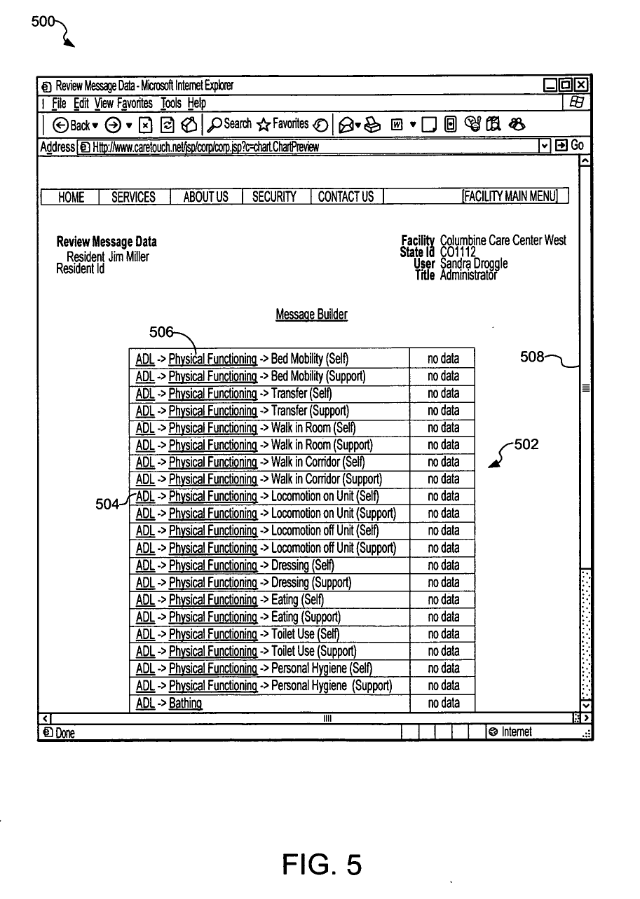

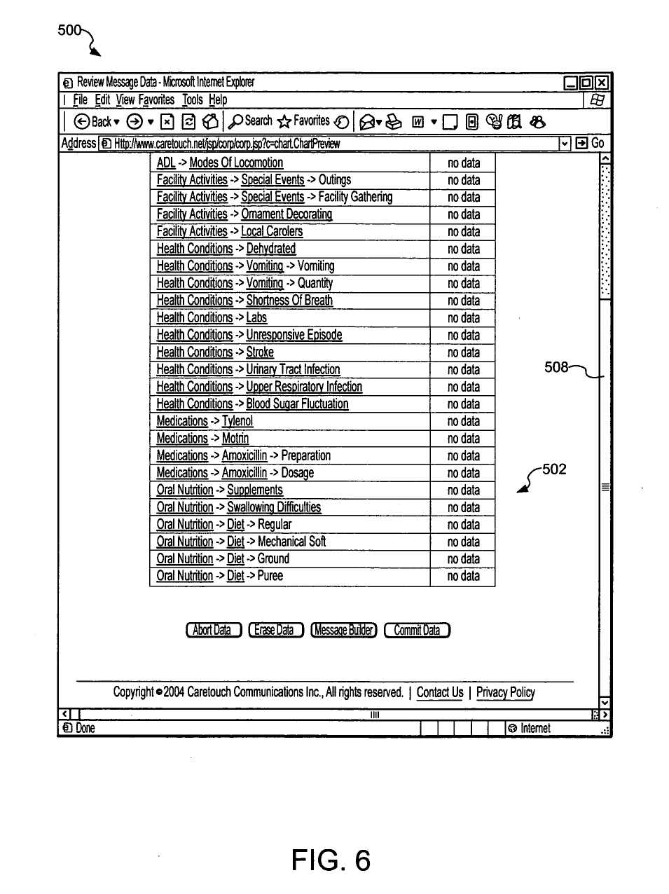

FIG. 4 illustrates another user interface 400 wherein the user has selected category ‘Oral Nutrition’. Under category ‘Oral Nutrition’, category element menu 402 includes category elements ‘Supplements’, ‘Swallowing Difficulties’, and ‘Diet’. In the example, the user has selected ‘Swallowing Difficulties’. In this case, ‘Swallowing Difficulties’ is also the name of the sub-element. Sub-element ‘Swallowing Difficulties’ 404 can take one of the values ‘No data’, ‘Yes’, and ‘No’. Selectable buttons 406 enable the user to set the appropriate value for ‘Swallowing Difficulties’. At any time, the user may view all the data that has been entered by selecting hyperlink ‘Review Message Data’ 408. When the user selects ‘Review Message Data’ 408, a web page, such as the web page shown in FIGS. 5-6 is presented.

FIG. 5-6 illustrate a user interface 500 that presents the LTC data that has been entered for the client. In this particular embodiment, the LTC data is presented in a table 502. The table includes a row for each combination of category, element, and sub-element. The value for the sub-element is shown on the right column. In the particular example, no data has yet been entered for any of the combinations of category, element, and sub-element. The user may select category hyperlinks 504 or element hyperlinks 506 to bring up a user interface for entering data related to the selected category or element. The user may manipulate scroll bar 508 to view more of the table 502.

FIG. 7 is a block diagram illustrating exemplary functional modules and data structures in a particular embodiment of an IMDS 116. The various functional modules and data structures shown can be implemented in hardware, software, firmware, or any combination of those. Generally, the modules include interfaces that enable the modules to communicate with each other, as well as to external systems that are utilizing the IMDS 116.

In a particular embodiment, the IMDS 116 is implemented in a hypertext transport protocol (HTTP) server and a database server. In this embodiment, the data structures can be implemented in a relational database 122 that is accessible by functional modules executing on the HTTP server. Some of the functional modules provide interfaces to the data structures, enabling creation, deletion, editing, and access to the information in the data structures. Among other functionality, the IMDS 116 can be used to manage applications, build messages, deliver messages, and handle responses to the messages, just to name a few.

An IMDS manager module 702 manages interaction with applications provided by notification services. In this capacity, the IMDS manager module 702 handles registration of applications that want to use the IMDS 116 for message delivery. In one embodiment, registration of the application is web-based, wherein a web form is completed online. The web form prompts for and accepts data that identifies the application, such as the name and location. In addition, the web form prompts for and accepts information to enable interaction with the application, such as, but not limited to, interface definitions, data elements, data element types, and script components.

In accordance with an embodiment, the IMDS manager module 702 accepts new script components when the application is registered or after registration. In this embodiment, a user, such as an application administrator is presented with application data categories or elements. For each application data category or element, the application administrator can enter a corresponding script component (e.g., a script segment). The IMDS manager module 702 compiles the new script components into a data structure referred to as an extensible script components data dictionary 730. After a script component is entered into the IMDS 116, it is an active script component, which means that it may be retrieved from the data structure and used to build messages for delivery to member(s) of the distribution community.

According to some embodiments, after script components are entered into the IMDS 116, active script components can be expired. Via an interface (e.g., a web form), the application administrator is presented with a list of active script components, each of which can be selected for expiration. When the selected script components are submitted for expiration, the IMDS manager 702 deactivates (e.g., deletes, marks for nonuse, etc.) them within the data structure.

Because the IMDS 116 can be utilized by a broad range of applications in different industries, script components can be offered or employed based on the particular application or industry. An application product-specific script component dictionary 732 is generated when an application is registered. The application product-specific script component dictionary 732 defines associations between data categories, elements, or values used by the application and script segments, codes, or other data. The data categories, elements, sub-elements, and values can be those that are used as a standard in the industry.

In one embodiment, the application product-specific dictionary 732 is produced by a notification service offering the application. At registration time, the notification service sends the application product-specific dictionary 732 to the IMDS 116. The application product-specific dictionary 732 will specify codes (e.g., component IDs) that will be used during operation when messages are recorded. The application product-specific component dictionary 732 can include industry-specific components. For example, in the assisted living industry, industry-specific script components can include data categories from any version of the minimum data set (MDS), which are standard for that industry.

In another embodiment, the IMDS 116 can offer selectable sets of industry-specific script components that different notification services can select. For example, sets of industry-specific script components can be offered for the automotive industry, the health education industry, and others. At registration time, the appropriate set of industry-specific script components can be selected. In the case of the LTC notification service 112, script components corresponding to the long term care industry will generally be selected.

In accordance with an embodiment, a service broker module 704 enables affiliate applications to be registered with the IMDS 116. The service broker module 704 interfaces with the notification service to register affiliate applications. An affiliate application is another application affiliated with a primary application that can be offered by the notification service. In some embodiments, an affiliate application can be an extension of another primary application concerning a client. In other embodiments, an affiliate application may be separate from a primary application and pertain to a different client. Application information is stored in application data structure 734.

In accordance with an embodiment, a profile manager 706 enables management of profiles related to subscribers and/or registered clients. Through an interface to the profile manager 706, notification services can upload one or more client profiles 736 and/or subscriber profiles 738 to the IMDS 116. As discussed above, client profiles include information pertinent to the client. A client profile 736 can include, but is not limited to, name, address, nicknames, hobbies, birth date, health conditions, or categories of information that the client allows to be released. Subscriber profiles 738 include information related to the subscriber such as name, address, service level, categories of information that the subscriber is interested in, member(s) in the distribution community, contact information, billing information (e.g., credit card), and so on.

After receiving the profiles, the profile manager 706 stores them so that they can be used later during the message building and delivery process. Embodiments of the profile manager 706 also allow for profiles 734, 736 to be edited and/or deleted.

In accordance with an embodiment of the IMDS 116, a queue broker 708 manages initiation of processes within the IMDS 116. The queue broker 708 receives requests to perform transactions, such as building or delivering messages. The queue broker 708 puts transactions on a queue to be initiated at selected execution times.

An embodiment of the IMDS 116 includes a message builder 710 that builds a message to be delivered to a recipient (e.g., subscriber and/or members of a distribution community). In one embodiment, the message builder 710 receives key information defining the message and identifying the recipient. The key information could include a subscriber's profile 738, the client's profile 736, a history of previous script templates that have been delivered to the recipient, or other data.

In one embodiment, the message builder 710 uses the key information and one or more available script templates 740 to build a script that can be delivered to the recipient in the form of a human-understandable message. Generally, a script template 740 specifies the format of the script. In this embodiment, the message builder 710 selects one of the available script templates 740 using script selection criteria. Script selection criteria generally refers to rules or tests used to determine which script template 740 should be used to generate the script.

In one embodiment, a script template 740 is selected based on what script templates have been used in the past. In this embodiment, the message builder 710 generates a historical list of script templates 740 that have been used to create messages for delivery to the recipient. Based on the list, the message builder 710 identifies one or more script templates among the set of available script templates 740 that have not been used to generate a human-understandable message. The message builder 710 can select from the unused available script templates 740 in a random fashion, in order-of receipt or creation, or in some other order. In one embodiment, if all of the available script templates 740 have been used, the message builder 710 selects the least recently used script template 740.

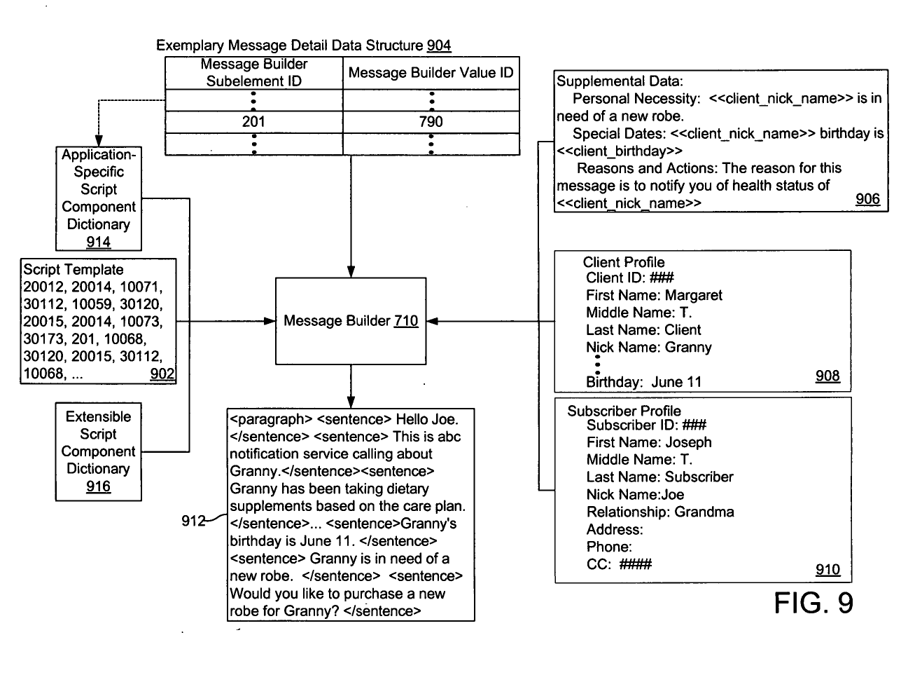

In one embodiment, the script templates 740 can be generated when an application is registered by a notification service and/or when client profiles 736 and subscriber profiles 738 are received. Typically, multiple script templates 740 are created that can be used to express human-understandable ideas in a number of different ways. For example, a different introductory greeting may be included in different script templates 740. As another example, the order of categories of data within the script may be different for different script templates 740. In this manner, messages delivered to the recipient can be different from one delivery to the next, thus achieving freshness of the messages. The script templates 740 can be manually created by a user at the IMDS 116 or the script templates 740 can be obtained from another source, such as the notification service. Script templates 740 are illustrated in more detail below in regard to FIG. 9 with a particular exemplary scenario using a script template.

Another module, the message scheduler module 712 performs tasks related to scheduling delivery of messages to recipient(s). In one embodiment, delivery is via telephone. In this embodiment, the message scheduler module 712 schedules a telephone call based on the subscriber profile 738, in which the subscriber previously specified a preferred message delivery time window. The message scheduler module 712 can further refine the scheduled time based on system call capacity information. Call capacity information specifies the number of calls that can be handled by the IMDS 116, which can depend on the available hardware and telephone services.

In accordance with one embodiment, after the message scheduler module 712 determines a delivery time, the script from which the human-understandable message will be generated is stored in a delivery schedule 742. The delivery schedule 742 can include a number of call slots. Generally, a call slot is an entry in memory that associates a scheduled time with a message to be delivered at that time. The delivery schedule 742 can include the call slots for all scheduled messages for an upcoming time range (e.g., next week). When the scheduled time arrives for a particular call, the scheduled call is triggered for delivery.

Embodiments of the IMDS 116 include a message delivery module 714, which facilitates delivery of human-understandable messages according to the delivery schedule 742. In one embodiment, the message delivery module 714 communicates the script and recipient contact information to a voice gateway 118. The voice gateway then converts the human-understandable message to audio, using text-to-speech (TTS) functionality. In another embodiment, the message delivery module 714 communicates the script and recipient contact information to a HTTP Web interface. The script can be stored as a human-understandable text message or human-understandable audio file on the HTTP Web interface. For example, the script may be converted to a .wav, .mp 3, .au, or other audio file.

A verification module 716 performs tasks related to verifying users (e.g., authorized members or unauthorized members) who attempt to access registered applications. The verification module 716 can use any verification scheme, such as, biometric verification, password verification, pin number verification. The verification module 716 interacts with subscriber profiles 738 to obtain verification information to compare to user input.

A message retriever 718 enables authorized members to retrieve previously generated human-understandable messages. The message retriever 718 can accept calls from users and interact with the verification module 716 to verify whether users are authorized prior to delivering requested messages. In one embodiment, the message retriever 718 presents a user interface to the authorized user through which the user can select a message. The script associated with a selected message is then delivered using the message delivery module 714.

A log manager 720 logs data during IMDS 116 execution. The log manager 720 stores the data in log data structure 744. Exemplary data that may be logged includes time and date of delivery of messages. Other data 746 represents any other data that may be required by the IMDS 116 to perform its operations.

In some embodiments, a data source selector 722 is operable to select data sources other than the data sources within the IMDS 116. Typically, the data source selector 722 is used to select any data that is not captured through the message builder interface of the notification service, but through some vendor provided data recording system. For example, in the case of an assisted living facility, the vendor provided data recording system could be a clinical charting system such as those offered by MCKESSON, ADL DATA SYSTEMS, or KEANE. In these cases, the data source selector 722 is able to select an appropriate data source (e.g., via the network 114), utilizing a data source's metadata definition associated with the data source, from which to gather the data.

A script template generator 724 can generate the script templates 740. In one embodiment, the script template generator 724 presents a user interface through which a user at the IMDS 116 can define script templates 740. In an alternative embodiment, the script template generator 724 receives script templates from another source, such as a notification service, and stores the received script templates 740 in the database 122.

Note that in this description, in order to facilitate explanation, the IMDS 116 and the database 122 are each generally discussed as if it is a single, independent network device or part of single network device. However, it is contemplated that the IMDS 116 and the database 122 may each actually comprise multiple physical and/or logical devices connected in a distributed architecture; and the various functions performed may actually be distributed among multiple of such physical and/or logical devices. Additionally, in alternative embodiments, the functions performed by each of the IMDS 116 and the database 122 may be consolidated and/or distributed differently than as described. For example, any function can be implemented on any number of machines or on a single machine. Also, any process may be divided across multiple machines. Finally, encryption may be performed at various levels of the application flow. For example, encryption may be performed on the scripts, or data structures within the database 122.

While data structures are shown as being embodied in a relational database 122, 124, 126, it will be understood by those skilled in the art that any data storage and/or association mechanism can be used. In some embodiments, data structures, such as the application product-specific script component dictionary 732 or the extensible script component dictionary 730, may be embodied in one or more flat files. In other embodiment, the data structures may be embodied in spreadsheets.

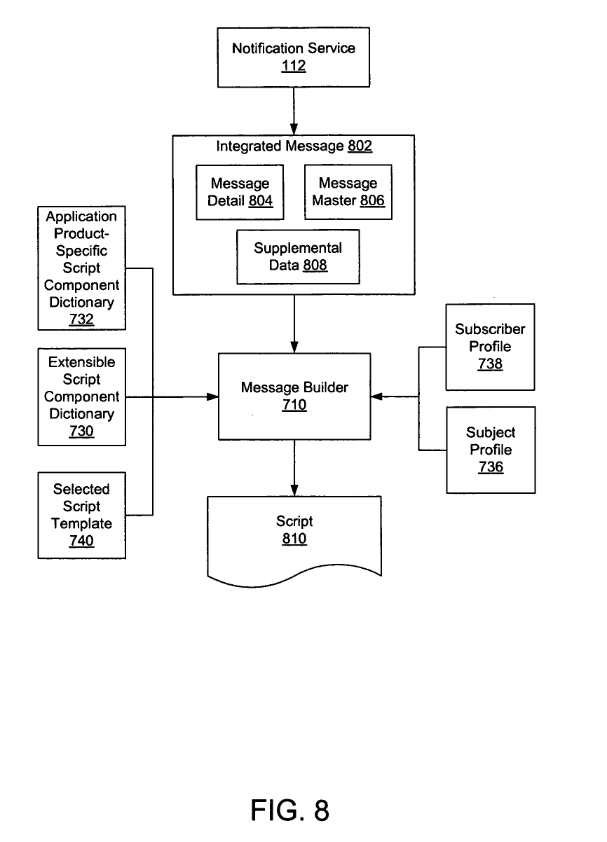

FIG. 8 illustrates an embodiment of a message building scheme. The notification service 112 generates an integrated message 802. Generally, the integrated message 802 describes data related to a client for delivery to a recipient. The data is typically obtained by a notification service 112 from a service provider 112 and put into a format useable by the IMDS 116.

In the particular embodiment, the integrated message 802 includes a message detail data structure 804, a message master data structure 806, and supplemental data 808. In this embodiment, the integrated message 802 generally defines the components that will be used to generate a script that can be used to generate a corresponding human-understandable message.

Elements of an exemplary message master data structure 806 are shown below:
MSG_BLDR_MASTER_ID: Unique ID for each row created
MSG_BLDR_CHAIN_SERVICE_PROVIDER_ID: ID for the application product-specific script component definition
MSG_BLDR_CHAIN_ID: ID for the chain
MSG_BLDR_SERVICE_PROVIDER_ID: ID for the service provider
MSG_BLDR_CLIENT_ID: ID for the client
MSG_BLDR_SERVICE_PROVIDER_USER_ID: ID for the service provider user
MSG_BLDR_DATE: Date of the recording, format of “YYYYMMDDHH 24 MI”

Elements of an exemplary message detail data structure 804 are shown below:
MSG_BLDR_MASTER_ID: ID of associated Message Master
MSG_BLDR_DETAIL_ID: Unique ID for each row created
MSG_BLDR_CATEGORY_ID
MSG_BLDR_ELEMENT_ID
MSG_BLDR_SUB_ELEMENT_ID

MSG_BLDR_VALUE_ID

TABLE 1
Exemplary Message Detail Data Structure

| | | | MSG | | |
|---|---|---|---|---|---|
| MSG | MSG | MSG | BLDR | MSG BLDR | MSG |
| BLDR | BLDR | BLDR | ELE- | SUB | BLDR |
| MASTER | DETAIL | CATEGORY | MENT | ELEMENT | VALUE |
| ID | ID | ID | ID | ID | ID |
| 10 | 110 | 27 | 125 | 235 | 880 |
| 10 | 111 | 22 | 98 | 201 | 790 |
| 10 | 112 | 25 | 115 | 224 | 859 |
| 10 | 113 | 27 | 126 | 237 | 884 |
| 10 | 114 | 25 | 113 | 221 | 845 |
| 10 | 115 | 22 | 100 | 204 | 796 |
| 10 | 116 | 27 | 127 | 238 | 886 |
| 10 | 117 | 22 | 99 | 202 | 792 |
| 10 | 118 | 25 | 116 | 225 | 862 |
| 10 | 119 | 27 | 125 | 236 | 882 |

Table 1 illustrates an exemplary message detail data structure that could be generated by the notification service and sent to the IMDS. Of particular importance are the codes in the columns labeled “MSG_BLDR_SUB_ELEMENT_ID” and “MSG_BLDR_VALUE_ID”. These codes are used as indexes into an application product-specific script component data structure (e.g., application product-specific script component dictionary), such as that shown in Table 2, below. Generally, the application product-specific script component data structure provides script components associated with application product-specific data categories.

In some embodiments, the codes (e.g., component IDs, Sub-element IDs, Element IDs, Value IDs, etc.) in the data structures described herein can be system generated to ensure that no codes are improperly used to mean two different things. However, generation of the codes is not limited to system generation.

Supplemental data 808 can include, but is not limited to, data elements related to the particular application. In the case of an assisted living environment, the supplemental data 308 may include phrases related to a resident receiving care from an assisted living facility. Thus, for example, supplemental data 808 may include survey questions, special dates, personal necessities, reasons for the message, actions taken, and others related to the client. A particular example is illustrated in FIG. 9 and described in detail below.

The message builder uses the integrated message 802, the application product-specific script component dictionary 732, the extensible script component dictionary 730, a script template 740, the subscriber profile 738 and the client profile 736 to generate script 810. To illustrate, FIG. 9 presents specific exemplary data for each of the data elements. Prior to describing FIG. 9 in detail, embodiments of an exemplary application product-specific script component dictionary, and exemplary extensible script component dictionary are presented, and will be used in the illustration of FIG. 9.

Table 2, shown below, is an exemplary application product-specific script component dictionary 732 in accordance with one embodiment. The application to which data in Table 2 relates is the long term assisted living care application.

TABLE 2
Exemplary Application Product-Specific Script Components Table

| MSG BLDR | | | | |
|---|---|---|---|---|
| SUBELEMENT | MSG BLDR | | VALUE | |
| ID | VALUE ID | NAME | NAME | SEGMENT DATA (translation) |
| 201 | 790 | Supplements | Yes | has been taking dietary supplements |
| | | | | based on the care plan |
| 201 | 791 | Supplements | No | has been refusing the intake of dietary |
| | | | | supplements |
| 202 | 792 | Swallowing Difficulties | Yes | is having difficulties swallowing |
| 202 | 793 | Swallowing Difficulties | No | is able to swallow normally |
| 204 | 796 | Mechanical Soft | Yes | has been eating mechanically softened |
| | | | | food |
| 204 | 797 | Mechanical Soft | Yes | has not been eating mechanically |
| | | | | softened food |
| 221 | 845 | Dehydrated | Yes | has been dehydrated |
| 221 | 846 | Dehydrated | No | has not been dehydrated |
| 224 | 859 | Shortness Of Breath | Yes | has struggled with breathing, when |
| | | | | moving about during the day |
| 224 | 860 | Shortness Of Breath | No | had no problems breathing |
| 225 | 861 | Labs | Yes | had lab results |
| 225 | 862 | Labs | No | had no lab results for this period |
| 235 | 880 | Outings | Yes | attended the regularly scheduled |
| | | | | activity |
| 235 | 881 | Outings | No | did not attend the regularly scheduled |
| | | | | activity |
| 236 | 882 | Facility Gathering | Yes | attended the most recently scheduled |
| | | | | facility gathering |
| 236 | 883 | Facility Gathering | No | did not attend the last facility |
| | | | | gathering |
| 237 | 884 | Ornament Decorating | Yes | last Wednesday, <<origin_nick_name>> |
| | | | | participated in a Christmas ornament |
| | | | | decorating activity |
| 237 | 885 | Ornament Decorating | No | <<origin_nick_name>> missed last |
| | | | | wednesday's Christmas ornament |
| | | | | decorating activity |
| 238 | 886 | Local Carolers | Yes | Carolers from, Blevins Junior High |
| | | | | School, visited Columbine Care Center |
| | | | | West, and sang Christmas songs for the |
| | | | | residents. </sentence><sentence>Your |
| | | | | <<origin_nick_name>>, listened to the |
| | | | | songs, and joined in, as the whole |
| | | | | group sang, Silent Night. |

In Table 2, the column labeled “Msg Builder Sub-element ID” includes application product-specific codes that are used to indicate a corresponding name and segment. The column labeled “Msg Builder Value ID” includes possible values associated with the codes in the first column. The column labeled “Name” provides a name associated with the code in the first column. The column labeled “Value Name” provides a name associated with the value ID in the second column. The column labeled “Segment Data” includes an actual phrase corresponding to the value ID and value name. Thus, for example, a response of “Yes” as to whether the resident is taking her supplements corresponds to code 201 (“Supplements”), code value 790 (“Yes”) and segment data “has been taking dietary supplements based on the care plan.”

The application product-specific script components data structure includes sub-elements of data and values related to the data sub-elements. The values can be obtained during the message data collection by the notification application. In one embodiment, when message data is gathered by the notification application from the service provider, the application maps the data entries to associated codes in the “Message Builder Sub-element ID” and/or “Message Builder Value ID” columns. The notification application then creates a data structure such as the Message Detail Data Structure and the Message Master Data Structure shown above.

In one embodiment, the message builder 710 can use Message Detail Data Structure (e.g., Table 1) and the application product-specific script components data structure (e.g., Table 2) in conjunction to determine the script segment. Both tables include columns labeled “Message Builder Sub-element ID” and “Message Builder Value ID” The message builder 710 first looks in Table 1 for a specified Sub-element ID (specified in the script template, as discussed herein), and obtains the Value ID that was entered during the message data recording by the notification application. Using the determined Value ID, the message builder 710 determines the proper script segment from Table 2.

One or more data categories in the exemplary Table 2 can be industry-specific. For example, the data category “Swallowing Difficulties” corresponds to data categories specified in the Minimum Data Set (MDS), which is a standard data set used by the assisted living industry. However, the application product-specific script component dictionary 732 is not limited to MDS data categories. MDS 2.0 was used in the example shown here; however, any version of MDS can be used. Indeed, any other standard data set appropriate to the application can be used. When the IMDS is used for another industry (e.g., automotive, newborn babies, etc.), standard data categories for that industry can be used.

Data in the application product-specific script component dictionary 732 can be obtained from multiple sources. For example, in the context of the assisted living facility, some script segments may be obtained from a clinical recording chart from a vendor, such as MCKESSON, ADL DATA SYSTEMS, or KEANE. Script segments from other sources can be defined in the application product-specific script component dictionary with their own identifiers.

Table 3 below is an exemplary extensible script components table in accordance with one embodiment. For illustration, Table 3 includes three exemplary types of segment types: Assisted Living Provider types, English types, and voice extensible markup language (VXML) types.

TABLE 3
Exemplary Extensible Script Components Table

| | | SCRIPT | |
|---|---|---|---|
| SEGMENT | | COMPONENT | |
| TYPE | SEGMENT NAME | ID | SEGMENT DATA |
| Assisted | Message Category | 10089 | <<adl>> |
| Living | | | |
| Provider | | | |
| | Message Category | 10088 | <<facility_activities>> |
| | Message Category | 10087 | <<health_conditions>> |
| | Message Category | 10090 | <<medication>> |
| | Message Category | 10086 | <<oral_nutrition>> |
| | client_first_name | 10066 | <<client_first_name>> |
| | client_full_name | 10065 | <<client_full_name>> |
| | client_gender | 10069 | <<client_gender>> |
| | client_last_name | 10067 | <<client_last_name>> |
| | client_nick_name | 10068 | <<client_nick_name>> |
| | recipient_first_name | 10059 | <<recipient_first_name>> |
| | recipient_full_name | 10058 | <<recipient_full_name>> |
| | recipient_gender | 10064 | <<recipient_gender>> |
| | recipient_last_name | 10060 | <<recipient_last_name>> |
| | recipient_nick_name | 10061 | <<recipient_nick_name>> |
| | recipient_client_nick_name | 10062 | <<recipient_client_nick_name>> |
| | target_relationship | 10063 | <<recipient_relationship>> |
| | Message Category | 10091 | <<vital_signs>> |
| | ChartBuilder | −1 | Chartbuilder |
| | greeting 1 | 10070 | greetings |
| | greeting 2 | 10071 | hello |
| | greeting 3 | 10072 | hi |
| | announcement 1 | 10073 | this is abc notification |
| | | | service calling |
| | announcement 2 | 10074 | this is a message from abc |
| | | | notification service |
| | ABC notification service | 10077 | health status update |
| | Message Category | 10080 | oral nutrition |
| | Message Category | 10081 | facility activities |
| | Message Category | 10082 | health conditions |
| | Message Category | 10083 | adl |
| | Message Category | 10084 | medication |
| | Message Category | 10085 | vital signs |
| | Message element | 10092 | diet |
| | Message element | 10093 | supplements |
| | Message element | 10094 | swallowing difficulties |
| | Message element | 10095 | vomiting |
| | Message element | 10096 | urinary track infection |
| English | punctuation space | 30112 | |
| | punctuation exclamation | 30118 | ! |
| | punctuation double | 30117 | ” |
| | quotation | | |
| | punctuation apostrophe | 30113 | ' |
| | punctuation single | 30123 | ‘ |
| | quotation | | |
| | pronoun | 30173 | about |
| | subordinate conjunction | 30137 | after |
| | time 1 | | |
| | subordinate conjunction | 30149 | although |
| | opp 1 | | |
| | coordinating conjunction 2 | 30128 | and |
| | pronoun | 30166 | are |
| | subordinate conjunction | 30146 | as |
| | c + e 4 | | |
| | subordinate conjunction | 30143 | because |
| | c + e 1 | | |
| | subordinate conjunction | 30138 | before |
| | time 2 | | |
| | correlative conjunction 1 | 30133 | both |
| | coordinating conjunction 4 | 30130 | but |
| | pronoun | 30167 | calling |
| | pronoun | 30174 | concludes |
| | verb | 30162 | consists |
| | verb | 30161 | contains |
| | correlative conjunction 2 | 30134 | either |
| | subordinate conjunction | 30157 | even if |
| | cond 5 | | |
| | subordinate conjunction | 30151 | even though |
| | opp 3 | | |
| | verb | 30160 | follows |
| | coordinating conjunction 1 | 30127 | for |
| | subordinate conjunction | 30153 | if |
| | cond 1 | | |
| | subordinate conjunction | 30158 | in case |
| | cond 6 | | |
| | subordinate conjunction | 30147 | in order that |
| | c + e 5 | | |
| | pronoun | 30172 | information |
| | verb | 30159 | is |
| | pronoun | 30171 | message |
| | correlative conjunction 3 | 30135 | neither |
| | coordinating conjunction 3 | 30129 | nor |
| | correlative conjunction 4 | 30136 | not only |
| | subordinate conjunction | 30145 | now that |
| | c + e 3 | | |
| | preposition | 30163 | of |
| | subordinate conjunction | 30155 | only if |
| | cond 3 | | |
| | coordinating conjunction 5 | 30131 | or |
| | plural | 30126 | s |
| | subordinate conjunction | 30141 | since |
| | time 5 | | |
| | coordinating conjunction 6 | 30132 | yet |
| | pronoun | 30170 | your |
| vxml | vxml paragraph end | 20013 | </paragraph> |
| | vxml sentence end | 20015 | </sentence> |
| | vxml paragraph begin | 20012 | <paragraph> |
| | vxml sentence begin | 20014 | <sentence> |

In Table 3, the column labeled “Segment Type” includes names of the different segment types. The next column, labeled “Segment Name” provides a name of a segment. The column labeled “Segment Component ID” includes codes for the corresponding segment. The column labeled “Segment Data” includes the text, grammar, or tagged data in the script segment.

Extensibility allows for the notification service to add to and edit the extensible script component dictionary. In one embodiment, the IMDS can include the “English” and “VXML” segment types by default and the long term care (LTC) notification service can add the “Assisted Living Provider” segment types. In this manner, the notification service can create phrases that express the same meaning in different styles. For example, the notification service can create multiple greetings as shown in Table 1: greeting 1 is “greetings”, greeting 2 is “hello”, and greeting 3 is “hi”. Thus, embodiments are not limited to the script segment types shown in Table 3.

In an embodiment, extensibility also enables the notification service to create different message categories, different message elements, and/or different message sub-elements, values, and translations. For example, Table 3 includes message categories for ‘adl’ (activities of daily living), ‘facility activities’, ‘health conditions’, ‘health status update’, ‘medication’, ‘oral nutrition’, ‘vital signs’. Message elements include ‘supplements’, ‘swallowing difficulties’, ‘diet’, ‘vomiting’, and ‘urinary tract infection’.

Although English is shown as one possible type, embodiments are not limited to English language types. Any other language, and even multiple languages could be used, depending on the particular application. For example, script component types may be Japanese, German, French and others.

VXML types are types of tagged script segments that can be used by a text-to-speech system for converting a text-based script into an audio-based human-understandable message. Tagged script segments are not limited to VXML.

Turning now to FIG. 9, a simplified example is described for convenience of illustration. FIG. 9 will be described with reference to Tables 2 and 3 above. In the example shown, a portion of a selected script template 902, message detail data structure 904, and supplemental data 906 are input to the message builder 710. The Message Builder 710 acquires the all the pieces for assemblage. In the script template 902, exemplary script component IDs include codes: 20012, 20014, 10071, 30112, 10059, 30120, 20015, 20014, 10073, 30173, 10068, 30120, 20015, 30112, and 10068. The message detail data structure 904 includes exemplary codes, such as message builder sub-element ID 201 and message builder value ID 790.

The exemplary supplemental data 906 includes phrases: Personal Necessity: <<client_nick_name>> is in need of a new robe; Special Dates: <<client_nick_name>> birthday is <<client_birthday>>; Reasons and Actions: The reason for this message is to notify you of health status of <<client-nick_name>>.

In one embodiment, the message builder 710 accesses the associated client profile 908 and subscriber profile 910 and builds a script 912 based on profile data. For example, only categories of information the subscriber is interested in may be included; or only information the client allows to be released as indicated by their respective profiles. Thus, the subscriber profile 908 serves as a mechanism for messages to be customized for the subscriber.

Using the exemplary Table 2 (above) for the application product-specific script component dictionary 914 and Table 3 (above) for the extensible script component dictionary 916 and script template 902, a script 912 can be created. Table 4 illustrates an exemplary selected script template with data corresponding to the data shown in the exemplary scenario:

TABLE 4
Exemplary Script Template

| | | | MESSAGE |
|---|---|---|---|
| | | SCRIPT | BUILDER |
| SCRIPT | BUILD | COMPONENT | SUB |
| ID | ORDER | ID | ELEMENT ID |
| 1 | 1 | 20012 | −1 |
| 1 | 2 | 20014 | −1 |
| 1 | 3 | 10071 | −1 |
| 1 | 4 | 30112 | −1 |
| 1 | 5 | 10059 | −1 |
| 1 | 6 | 30120 | −1 |
| 1 | 7 | 20015 | −1 |
| 1 | 8 | 20014 | −1 |
| 1 | 9 | 10073 | −1 |
| 1 | 10 | 30173 | −1 |
| 1 | 11 | −1 | 201 |
| 1 | 12 | 10068 | −1 |
| 1 | 13 | 30120 | −1 |
| 1 | 14 | 30112 | −1 |
| 1 | 15 | 10068 | −1 |
| | | . | |
| | | . | |
| | | . | |

In Table 4, each row corresponds to a segment of the script. The column labeled “Sript ID” uniquely identifies the script. The column labeled “Build Order” provides numbers that indicate the order in which the script segments should be processed. The next columns, labeled “Script Component ID”, and “Message Builder Sub-element ID”, provide data that is mutually exclusive, which means that the message builder 710 uses data from only one of the columns. In this embodiment, the column that includes a non-negative value is to be used for the corresponding segment when building the human-understandable massage.

A script template can be embodied in any number of ways and formats as may be known by those skilled in the art. In one embodiment, the script template is embodied in an extensible markup language (XML) document. In other embodiments, script templates can be coded in a computer language such as ‘C’ programming language. In yet another embodiment, script templates can be created in an intermediate language, such as Java Bytes that can be interpreted by a virtual machine. The script template is used by the IMDS to generate a script, which can be delivered to a recipient as a human-understandable message.

The column labeled “Script Component ID” can include a list of unique script component identifiers in the form of codes. The codes can correspond to application product-specific scripts and/or application product-specific translations. The column labeled “Message Builder Sub-element ID” can include a list of unique codes for data elements to be put in the script 912. The Message Builder Sub-element IDs in Table 4 can be found in the Message Detail Data Structure shown in Table 1 above. The Message Builder Sub-element ID and the Message Builder Sub-element ID Value in Table 1 can be used to access a corresponding script segment from Table 2, the application product-specific script component dictionary.

According to the present example, the message builder 710 steps through each portion of the script template according to the “Build Order”For each component, if the script build data structure includes a non-negative value in the “Script Component ID”, the message builder 710 accesses the extensible script component dictionary 916 to resolve the code. If the component of the script build data structure includes a non-negative value in the “Message Builder Sub-element ID”, the message builder accesses a message detail data structure 904 and the application product-specific translations dictionary 914 to resolve the code.

Using the script template 902, the message builder 710 steps through the script segments in the specified order and looks each one up in the appropriate dictionary or data source. Using Tables 2 and 3 shown above, the script component IDs are mapped to the following corresponding script segments:

| | |
|---|---|
| 20012 = | <paragraph> |
| 20014 = | <sentence> |
| 10071 = | hello |
| 30112 = | <space> |
| 10059 = | <<recipient_first_name>> |
| 30120 = | . |
| 20015 = | </sentence> |
| 20014 = | <sentence> |
| 10073 = | this is abc notification service calling |
| 30173 = | about |
| 10068 = | <<client_nick_name>> |
| 30120 = | . |
| 20015 = | </sentence> |
| 30112 = | <space> |
| 20014 = | <sentence> |
| 10068 = | <<client_nick_name>> |
| 201, 790 = | has been taking dietary supplements |
| | based on the care plan |
| 30120 = | . |
| 20015 = | </sentence> |

Items tagged with double arrows (i.e., <<>>) indicate a context-sensitive segment. In this case, the context-sensitive segment is filled in using with content obtained from either the client profile 908 or a subscriber profile 910. In this particular example, the tagged item <<client_nick_name>> is replaced with ‘Granny’. The tagged item <<recipient_first_name>> is replaced with ‘Joe’.

After the script 912 is created, the message builder 910 merges the supplemental data 906 with the script 912. In the example shown, supplemental data 906 includes three data segments: personal necessity, special dates, and reasons and actions related to the message. Personal necessity refers to an item that the resident needs. Special dates refer to any special dates related to the resident. Reasons and actions provide reasons for the message and actions that may have been taken. Supplemental data 906 can include other information, such as, but not limited to, survey questions. When the message builder 710 is used to generate messages in industries other than the assisted living industry, supplemental information can include data segments associated with the particular industry or application.

In this particular example, when the supplemental data 906 is merged with the script, the script 912 results in:

“<paragraph> <sentence> Hello Joe. </sentence> <sentence> This is abc
notification service calling about Granny.</sentence><sentence> Granny
has been taking dietary supplements based on the care plan. </sentence>...
<sentence>Granny's birthday is June 11. </sentence> <sentence> Granny
is in need of a new robe. </sentence> <sentence> Would you like to
purchase a new robe for Granny? </sentence>”

For purposes of completing the exemplary scenario shown in FIG. 9, in one embodiment, a voice gateway calls the subscriber and, after verifying the subscriber, communicates the script using text-to-speech (TYS) conversion. The subscriber is enabled to respond to the question “Would you like to purchase a new robe for Granny?”. In one embodiment, the subscriber can respond by voice, in which case, the voice gateway uses voice recognition to encode and determine the response. In another embodiment, the subscriber can respond by pressing a button on his/her phone, in which case, the voice gateway determines the response using dual tone modulation frequency (DTMF).

The voice gateway communicates the subscriber's response to the intelligent message delivery system (IMDS). The IMDS can deliver the subscriber's response to the notification service. In some embodiments, the fulfillment notification module of the notification service can carry out tasks in response to the subscriber's response. For example, if the subscriber does want to purchase the robe for his/her grandma, the notification service can order the robe from an online retailer via the Internet. Conveniently, the notification service already has the subscriber's credit card information from the subscriber profile. Therefore, the notification application can bill the credit card and order the robe for delivery on behalf of the subscriber with no further effort on the part of the subscriber. After the robe is received by the client, another message can be delivered to the subscriber, indicating receipt.

Exemplary Operations

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware and software.

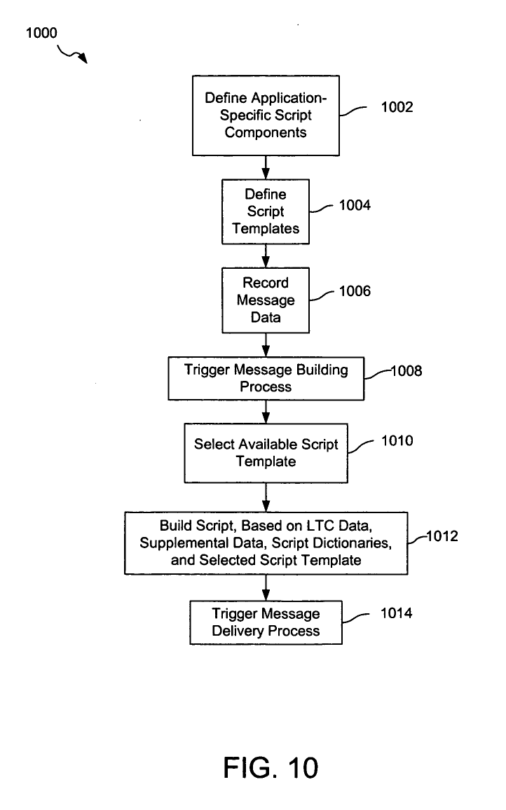

FIG. 10 illustrates an algorithm 1000 for creating a script based on dynamically generated application message data, predefined script components and a predefined script template. The algorithm 1000 may be carried out by one or more of the systems illustrated in FIG. 1 (e.g., the notification service 112 or the IMDS 116), either individually or in combination.

Before scripts can be built and messages delivered, script components and one or more script templates are defined. In a defining operation 1002, application product-specific script components are defined. Application product-specific script components can be defined in an application product-specific script component data structure, such as that shown in Table 2. The application product-specific script components can include industry-specific data categories. Alternatively, or in addition, application product-specific script components can be defined in an extensible script component data structure.

In one embodiment, the defining operation 1002 occurs when an application is registered by a notification service. In accordance with this embodiment, this can involve an administrator at the notification service accessing a user interface to define and enter script components. In another embodiment, the administrator can build the script component definitions in a document and send the document to the intelligent message delivery system (IMDS). In yet another embodiment, the intelligent message delivery system can provide a list of script components to choose from.

In a particular embodiment, the script components defined in the defining operation 1002 are stored in one or more data structures at the IMDS, such as script component dictionaries, from which they can be retrieved for use in building a script.

Another defining operation 1004 defines one or more script templates. Defining a script template involves defining an order of script segments identified in the predefined script components. A portion of an exemplary script template is shown above in Table 4 for purposes of illustration. In one embodiment, every script template has a specified number of script segments. In one embodiment, the script templates are defined by a user through a user interface (e.g., a graphical user interface GUI) that includes a drop down list of possible script components to include in the script template.

In one embodiment, the script templates can be categorized according to an associated data category, data element, data sub-element, or other criteria. For example, script templates referencing health status of residents in an assisted living facility may be in one category, while script templates referencing activities of daily living may be in another category.

In one embodiment, the defining operation 1004 involves defining many script templates (e.g., hundreds or thousands) so that a large variety of messages can be produced. Each script template can order categories of script segments in different orders. For example, in one script template, health status may come before activities of daily living, while in another script template activities of daily living comes before health status. In addition, different styles of phrasing may be used in different script templates. For example, one script template may include a script segment “Greetings” as the introductory greeting, while another script template includes a script segment “Hello” as the introductory greeting, while still another script segment includes “Hello <<recipient-first_name>>” as the introductory greeting. By creating multiple script templates with different ordering of script segments and different styles of phrasing, scripts and messages can be built that sound new (i.e., fresh) to the recipient.

After the script components and the script templates are defined, application message data is generated and recorded dynamically in a recording operation 1006. In one embodiment, the recording operation 1006 involves the notification service recording message data retrieved from the service provider. In this embodiment, a user at the service provider can enter message data through a user interface. The application of the notification service records the message data in the form of codes (e.g., script component IDs) and other supplemental data (e.g., alphanumeric text, phrases, etc.). The codes and supplemental data can be application product-specific. For example, for an assisted living service provider, codes can correspond to categories of assisted living care, and supplemental data can correspond to supplemental data related to a client. In one embodiment, the application sends the message data to the IMDS.

A triggering operation 1008 triggers a message building process to build a script based on the message data. A selecting operation 1010 selects a script template from one of the predefined script templates. The selected script template will be used to create the script. A building operation 1012 builds the script using the message data, predefined script component dictionaries, and the selected script template. In one embodiment, the building operation 1012 also uses a subscriber profile and a client profile to facilitate generation and/or customization of the script. After the script is built, another triggering operation 1014 triggers a message delivery process to cause the script to be converted to a human-understandable message and delivered to the subscriber.

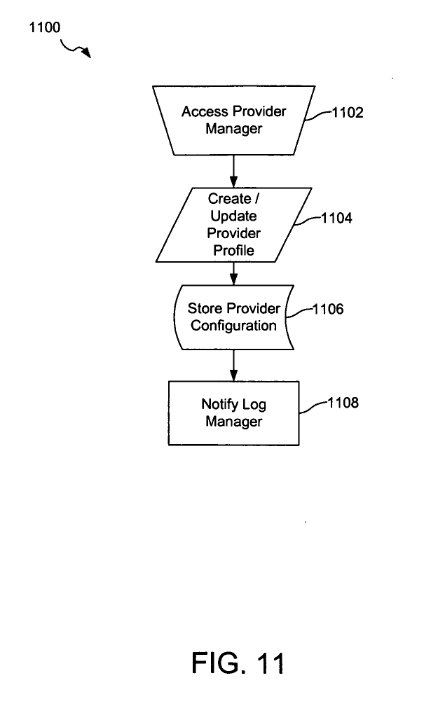

FIG. 11 illustrates an embodiment of an algorithm 1100 for managing assisted living service providers by a LTC notification service. Generally, the assisted living service providers are managed using information included in provider profiles, and can also include managing general information calendar information or other general information.

In an accessing operation 1102, LTC notification service staff accesses a provider manager user interface. The accessing operation 1102 may include selecting a particular provider to manage. In a creating/updating operation 1104, the LTC notification service staff creates and/or updates the provider profile corresponding to the assisted living provider that is being managed. The LTC notification service staff can create a new provider profile, for example when the provider is newly registered, or the LTC notification service staff can edit an existing provider profile. For example, the provider profile may be edited with new phone number, address, or staff members.

In a storing operation 1106, the created and/or edited provider profile is stored. In one embodiment, the provider profile is stored in a relational database. In another embodiment, the provider profile is stored in a flat file. A notifying operation 1108 then notifies the log manager that the provider profile was created and/or updated.

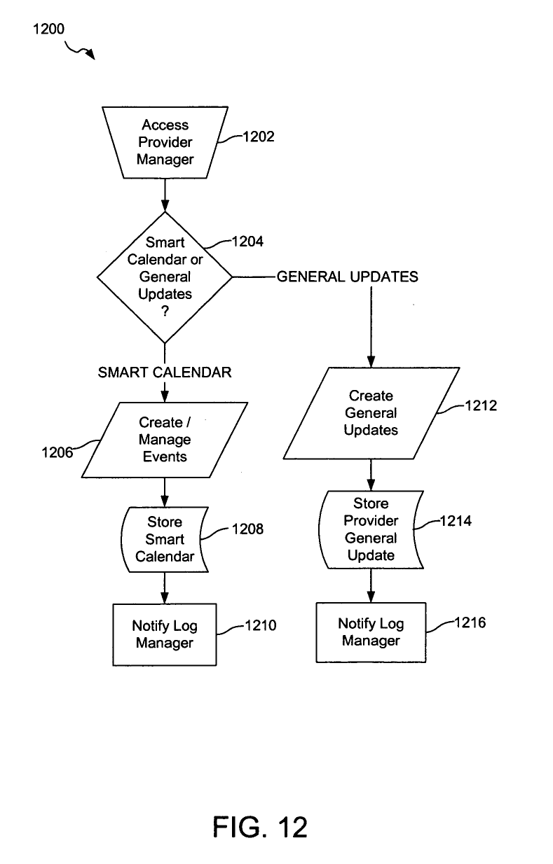

FIG. 12 illustrates another algorithm 1200 for managing assisted living service providers, but in this case, provider staff is accessing the provider manager user interface. In an accessing operation 1202, the provider staff accesses the provider manager user interface. In one embodiment, the accessing operation 1202 involves using an Internet browser to go to a provider manager user interface provided from an HTTP server. Typically, the provider staff will identify the assisted living service provider and may be prompted to log in to use the provider manager application.

In this embodiment, the provider staff can enter calendar information and/or general update information. A determining operation 1204 determines whether the provider staff wants to enter calendar information or general updates. If the staff selects the calendar option, the algorithm 1200 branches “SMART CALENDAR” to a creating/managing operation 1206. The creating/managing operation 1206 accepts entry from the staff person of information related to events to be stored in the smart calendar associated with the provider. After receiving the data entry related to the calendar, a storing operation 1208 stores the data in the provider's smart calendar. After the smart calendar is stored, a notifying operation 1210 notifies the log manager of the creation and/or management of the smart calendar.

If the determining operation 1204 determines that the staff has selected the general updates option, the algorithm branches “GENERAL UPDATES” to a creating operation 1212. The creating operation 1212 receives general update information from the provider staff. A storing operation 1214 then stores the general update information associated with the provider. A notifying operation 1216 notifies the log manager as to the general updates.

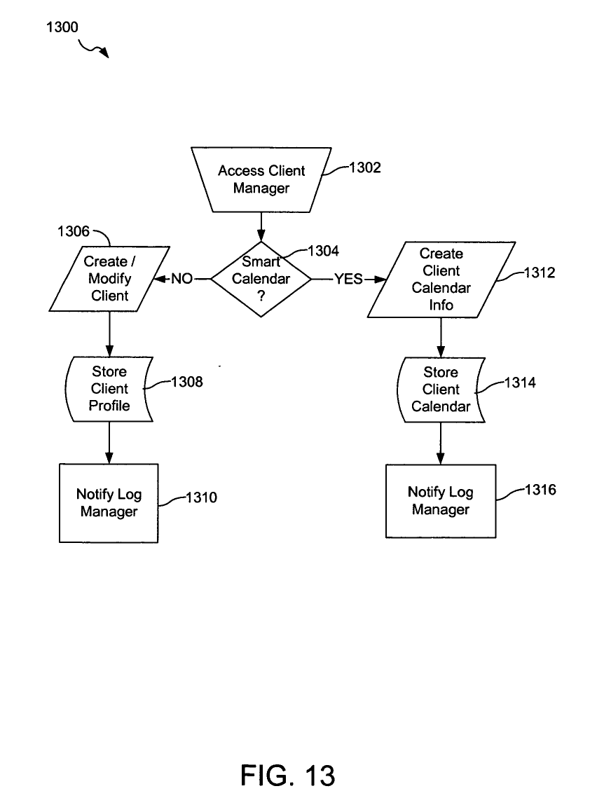

FIG. 13 illustrates an embodiment of an algorithm 1300 for managing information related to a client of an assisted living service provider. In the embodiment shown, a staff at the assisted living service provider accesses a user interface through which the staff can create, edit, and delete information related to a client. An accessing operation 1302 grants access to the provider staff to a user interface. After the staff identifies the provider and himself, the staff chooses whether to manage client smart calendar information or client profile information.

A determining operation 1304 receives and analyzes the staff's selection. If the staff selects to manage client profile information, the algorithm branches ‘NO’ to a creating/modifying operation 1306. The creating/modifying operation 1306 receives input from the staff person regarding creation of a client profile and/or changes to a client profile. After the client profile is created and/or modified, a storing operation 1308 stores the client profile. A notifying operation 1310 then notifies the log manager as to the creation and/or modification of the client profile.

Returning to the determining operation 1304, if the staff selects to manage the client smart calendar, the algorithm branches ‘YES’ to a creating operation 1312. The creating operation 1312 receives calendar information from the staff through the client manager user interface and creates corresponding smart calendar entries. The creating operation 1312 may format the received calendar information as needed. A storing operation 1314 stores the smart calendar as modified. A notifying operation 1316 notifies the log manager as to the changes to the client smart calendar.

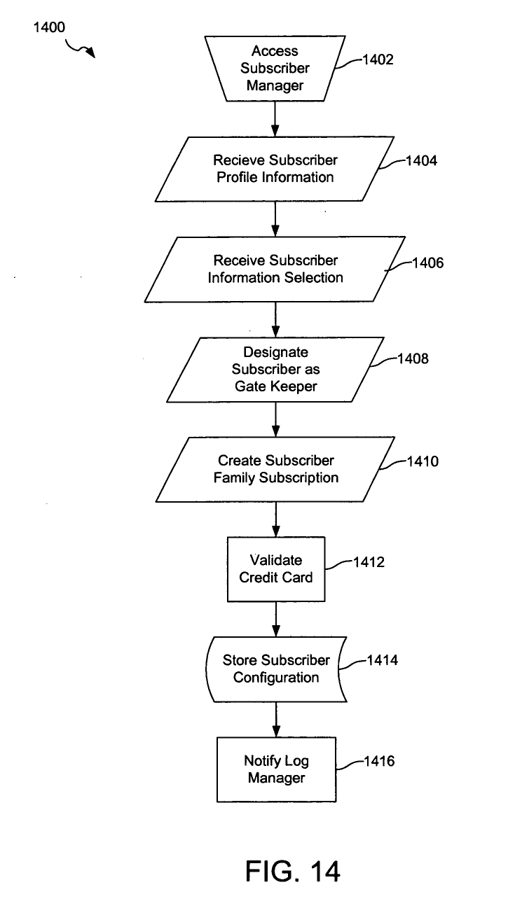

FIG. 14 illustrates an embodiment of an algorithm 1400 for managing subscriber information by an assisted living service provider. In this embodiment, the assisted living service provider can access a subscriber manager user interface (e.g., via the Internet) through which provider staff can create, edit, or delete subscriber information. Initially, in an accessing operation 1402, the provider staff is granted access to the subscriber manager user interface. In the accessing operation 1402, the staff identifies the assisted living service provider, the staff, and the relevant subscriber.

A receiving operation 1404 receives profile information associated with the subscriber. This can include receiving subscriber identification information, subscriber contact information, or other information.

Via the subscriber manager user interface, the provider staff can select among subscriber information that the staff wishes to create, edit, or delete. A selecting operation 1406 receives these selections from the provider staff. The algorithm uses the selections to determine which web page to the present to the provider staff and which data will be received.

An designating operation 1408 assigns the subscriber to the gatekeeper role for the subscriber's distribution community. The designating operation 1408 receives information related to the gatekeeper role, such as who is in the distribution community, what rights those members have, what information they are allowed to receive, and others.

A creating operation 1410 creates a family subscription associated with the subscriber. The creating operation 1410 receives information necessary to set up a family subscription, such as family member identifiers, addresses, contact information, and others. The creating operation 1410 then generates a family subscription data structure associated with the subscriber. A validating operation 1412 validates the subscriber's credit card to enable the subscriber to purchase items for the associated client using the credit card and to bill any subscription fees.

A storing operation 1414 stores subscriber configuration information, including the subscriber profile, the gatekeeper information, and the family subscription data structure. In one embodiment, the subscriber configuration information can be stored in a relational database. In other embodiments, the subscriber configuration information can be stored in other forms, such as flat files. A notifying operation 1416 notifies the log manager as to the management of the subscriber information.

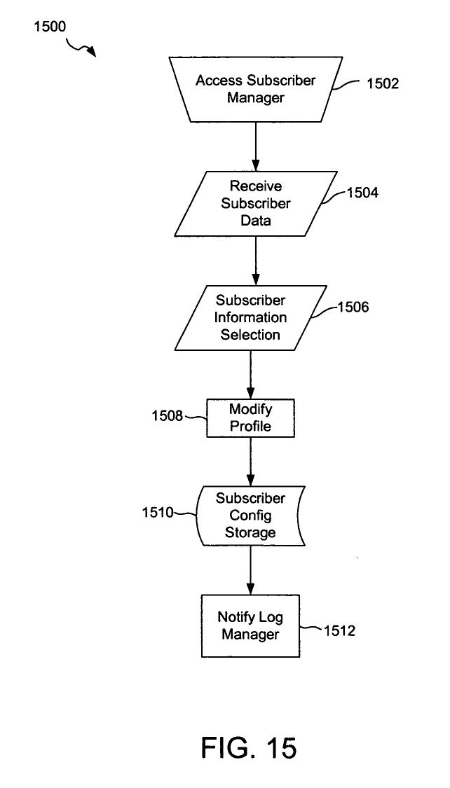

FIG. 15 illustrates an embodiment of an algorithm 1500 for managing subscriber information (e.g., subscriber profile) by the subscriber. In this embodiment, the subscriber accesses the subscriber manager in accessing operation 1502. In a receiving operation 1504, the subscriber enters subscribers profile information via a web interface. After the subscriber profile is created, the subscriber can modify the subscriber profile.

In a selecting operation 1506, the subscriber selects which profile information to modify. For example, the subscriber can change what categories of LTC information the subscriber wants to receive, the preferred days and times to receive the message, membership in the distribution community, and other information in the subscriber profile. In one embodiment, the subscriber can modify the profile over a telephony network. In another embodiment, the subscriber can modify the profile via a web interface over the Internet.

In a modifying operation 1508, the subscriber's profile is modified according to the subscriber's input. In a storing operation 1510, the modified profile is stored. A notifying operation 1512 notifies the log manager of the subscriber profile creation and/or edit process.

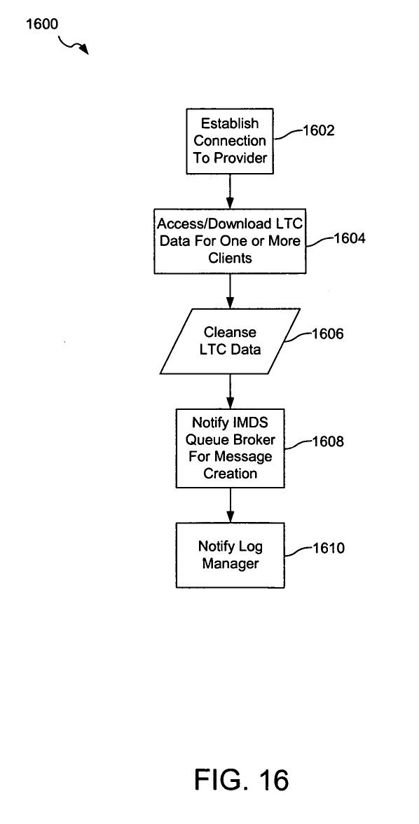

FIG. 16 illustrates an embodiment of an algorithm 1600 for obtaining long term care (LTC) information from an assisted living service provider using a direct interface to the assisted living service provider. The algorithm 1600 can be carried out by the provider consumer 212 shown in FIG. 2, or another applicable module. In one embodiment, the algorithm 1600 is carried out according to a schedule. For example, the LTC information can be obtained on a weekly basis. In one embodiment, the algorithm 1600 is use to obtain information from a vendor provided clinical charting system such as those offered by MCKESSON, ADL DATA SYSTEMS, or KEANE.

In an establishing operation 1602, a communication connection is established from the LTC notification service to the assisted living service provider. The connection may be wired or wireless or a combination thereof. The connection may be over a public network, such as the world wide web, or it may be established over a private network. In one embodiment, the establishing operation 1602 establishes a secure connection and validates the LTC notification service and staff member prior to granting access or establishing the connection to the assisted living service provider.

After the connection is established, a receiving operation 1604 receives LTC data related to one or more specified clients of the assisted living service provider. The LTC data can be formatted in any manner (e.g. XML, comma delimited, unknown with the structured defined in the header) or the like. LTC data can include any or all of the clinical data by the system being used at the service provider. (e.g. vital signs, medications, etc)

A cleansing operation 1606 cleanses the received LTC information. In one embodiment, the cleansing operation 1606 puts the received information into a form suitable for the IMDS. The cleansing operation 1606 can parse the information, remove unused formatting, reformat the content of the information, and so on, to prepare the information for use in a script and a human-understandable message.

A notifying operation 1608 notifies the queue broker of the IMDS that a message can be created using the LTC information received from the direct interface. In one embodiment, the LTC information is transmitted to the IMDS with an indicator that the LTC can be integrated with a script and/or a human-understandable message. Another notifying operation 1610 then notifies the log manager as to the receipt of the LTC information and the notification of the queue broker.

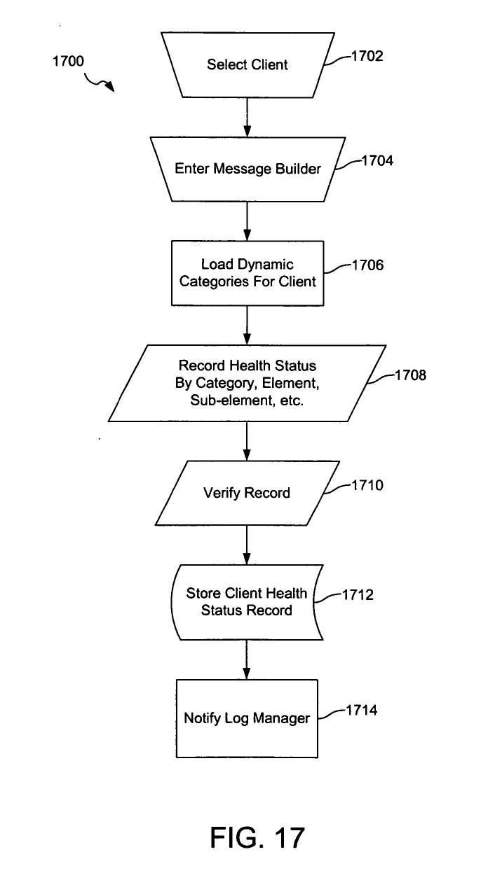

FIG. 17 illustrates and embodiment of an algorithm 1700 for obtaining LTC information via a user interface accessible by staff at an assisted living service provider. The algorithm 1700 can be carried out by the provider consumer module shown in FIG. 2, or another appropriate module. The algorithm 1700 is typically executed when staff access a message builder interface provided by the provider consumer. The staff typically use the message builder interface sometime after the staff have visited with or observed a client, and want to enter information the staff has gathered regarding the client. In some embodiments, the LTC notification service can remind the staff to enter LTC information through the message builder interface.

In a selecting operation 1702, the provider staff selects the client that the LTC information to be entered pertains. In one embodiment, the selecting operation 1702 involves receiving an input client name and searching a list of registered clients for the input name. After the staff selects the client, an accessing operation 1704 accesses the message builder user interface. A loading operation 1706 loads LTC data categories, which the staff can select and enter LTC data.

In a recording operation 1708, the staff enters the LTC information for the selected client. FIGS. 3 and 4 illustrate exemplary message builder interfaces that the provider staff could use to enter LTC data about a selected client. In one embodiment, while the staff is entering LTC information, the message builder of the LTC notification service generates message detail and message master data structures that represent the recorded LTC data. Thus, the recording operation 1708 can involve assigning recorded LTC category, element, sub-element, and value data with predefined numerical codes associated with those categories, elements, sub-elements, and values. The message detail and message master will then represent the recorded LTC information from the provider staff.

In a verifying operation 1710, the provider staff verifies that the recorded data is correct. In one embodiment, the staff is presented with a user interface such as the user interface shown in FIGS. 5 and 6, where the categories (and elements and sub-elements) for the client are presented to the provider staff along with the values that the staff recorded for them. The provider staff can then change any of the values that he recorded earlier.

In a storing operation 1712, the staff submits the recorded LTC information and the LTC information is stored. In one embodiment, the LTC information is stored in the form of the message detail data structure and the message master data structure. A notifying operation 1714 then notifies the log manager of the message building session.

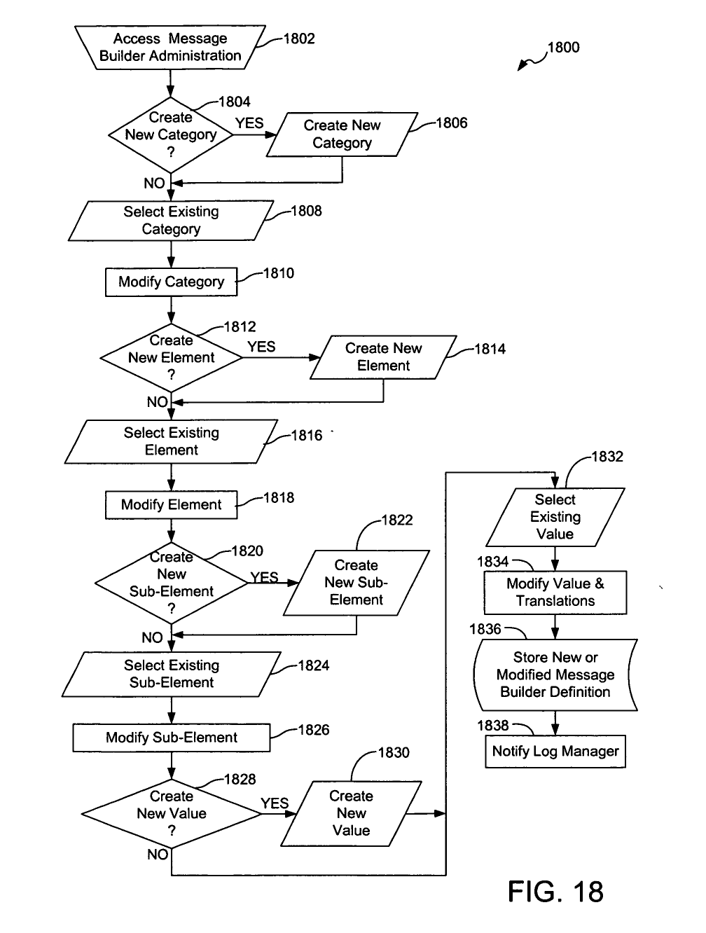

FIG. 18 illustrates an embodiment of a script component administration algorithm 1800 for administration of data used by the message builder. Using the algorithm 1800, a provider staff person, typically an administrator of the assisted living service provider, can create, edit, and delete categories, elements, sub-elements, values, and translations (e.g., script segments) associated with LTC information that can be input into the message builder. The algorithm 1800 can be carried out by the message builder administration module shown in FIG. 2, or another applicable module.

In an accessing operation 1802, the provider administrator access the message builder administration module. In one embodiment, the provider administrator logs into an Internet web page provided by the message provider consumer module of the LTC notification service. After accessing the message builder administration module, the provider consumer module can present the provider administrator with a series of web pages that enable the administrator to create or edit the categories, elements, sub-elements, values and/or translations.

In a first determining operation 1804 it is determined whether the administrator has chosen to create a new category. If so, the algorithm 1800 branches ‘YES’ to a creating operation 1806. In the creating operation 1806, information for the new category is entered by the administrator and received by the provider consumer module. The provider consumer module creates the new category in a data structure (e.g., an application product-specific script component dictionary) that associates categories, with elements, sub-elements, values and translations.

After creating a new category, a selecting operation 1808 selects a category to edit. The administrator can select a category for edit, and a modifying operation 1810 modifies the category according to administrator input. A determining operation 1812 receives input from the administrator and determines whether to create a new element associated with the selected category. If a new element is to be created, the algorithm 1800 branches ‘YES’ to a creating operation 1814. The creating operation 1814 receives information regarding the new element from the administrator, such as the name of the new element. The creating operation 1814 then associates the element with the selected category in the data structure.

After a new element is created, a selecting operation 1816 selects an element to edit. The administrator can select an element for edit, and a modifying operation 1818 modifies the selected element according to administrator input. Another determining operation 1820 receives input from the administrator and determines whether to create a new sub-element associated with the selected category and the selected element. If a new sub-element is to be created, the algorithm 1800 branches ‘YES’ to a creating operation 1822. The creating operation 1822 receives information regarding the new sub-element from the administrator, such as the name of the new sub-element. The creating operation 1822 then associates the sub-element with the selected category and the selected element in the data structure.

After a new sub-element is created, a selecting operation 1824 selects a sub-element to edit. The administrator can select a sub-element for edit, and a modifying operation 1826 modifies the selected sub-element according to administrator input. Another determining operation 1828 receives input from the administrator and determines whether to create a new value associated with the selected category, the selected element, and the selected sub-element. If a new value is to be created, the algorithm 1800 branches ‘YES’ to a creating operation 1830. The creating operation 1830 receives information regarding the value from the administrator, such as the name of the new value. The creating operation 1830 then associates the new value with the selected sub-element in the data structure.

The administrator can then select an existing value to modify in a selecting operation 1832. In a modifying operation 1834, the administrator can modify and existing value or an existing translation. A translation refers to a script segment. By modifying an existing translation, the administrator can change the meaning of an associated category/element/sub-element/value combination. The new or modified category, element, sub-element, value, and translation comprise a definition that can be used by the message builder during message building sessions. A storing operation 1836 stores the definition in the data structure. A notifying operation 1838 then notifies the log manager of the new or updated message builder definition.

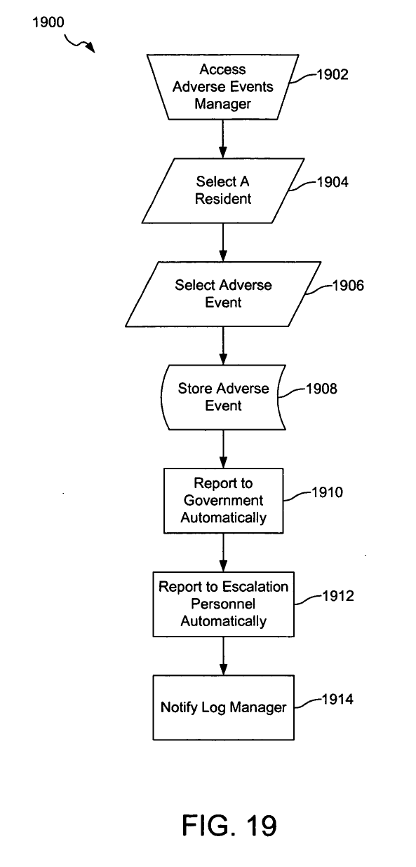

FIG. 19 illustrates an embodiment of an adverse events algorithm 1900 that can be carried out by the adverse events module of the LTC notification service shown in FIG. 2. Using the adverse events management interface of the LTC notification service, staff of assisted living service providers can document adverse events in a timely fashion and in a specified format for notification to the proper government authority. Initially, provider staff accesses the adverse event manager user interface in the accessing operation 1902.

In a selecting operation 1904, the client to whom the adverse event applies is identified and selected. In another selecting operation 1906, the appropriate adverse event is selected. In one embodiment, a list of possible adverse events is presented to the provider staff. The provider staff can select one or more of the adverse events and the adverse event manager captures the selection. In a storing operation 1908, the selected adverse event is stored in memory.

Later, at a specified time, a reporting operation 1910 reports the adverse event to the appropriate government agency. In one embodiment, reporting operation 1910 causes an electronic communication to be issued to the government agency that describes the adverse event, including the provider identification and client identification. In another embodiment, reporting operation 1910 causes a physical document to be printed that describes the adverse event, and the physical document is mailed, using traditional mail, to the proper government agency.

In a reporting operation 1912, the defined assisted living providers' personnel are notified automatically by electronic communication of the adverse event. This reporting describes the adverse event, including the provider identification and client identification. In another notifying operation 1914, the log manager is notified of the adverse events processing.

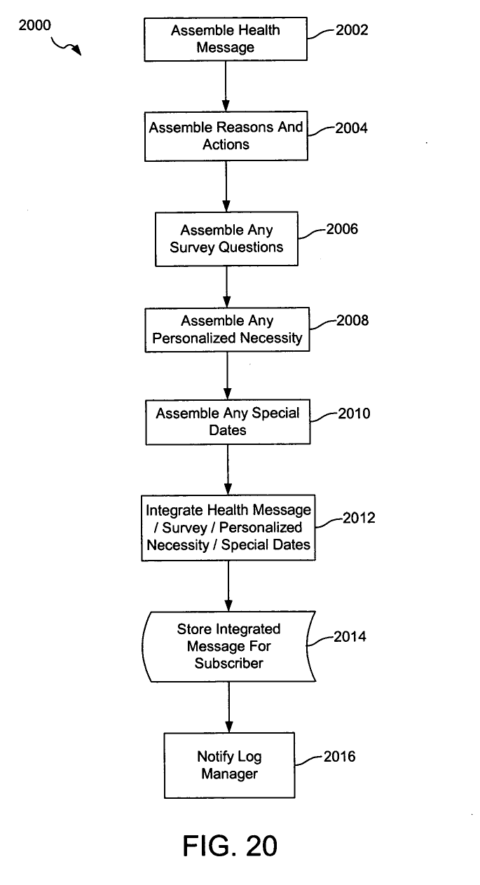

FIG. 20 illustrates an embodiment of a message management algorithm 2000 that can be carried out by the message manager of the LTC notification service shown in FIG. 2, or another applicable module. In general, the message management algorithm 2000 assembles all the pieces of the message into an integrated message (e.g., integrated message 802, FIG. 8) that can be used to generate a script and then a human-understandable message.

A first assembling operation 2002 assembles the health message data that was entered by the provider staff and/or was obtained from the provider records through the direct interface. Another assembling operation 2004 assembles any reasons and/or actions that the provider may have provided related to the health message. Reasons and/or actions, are extensions to the message builder recording session and are associated to the values of selected sub-elements. Reasons and/or actions are previously configured within the message builder administration utility. Another assembling operation 2006 assembles any survey questions that have been provided. Surveys have a specific configuration interface to be accessed by the facility and/or chain. Survey questions are distributed to the subscriber base to provide a consistent statistical sample and maintain this sample base on a on-going basis.

Another assembling operation 2008 assembles any personalized necessities that may have been identified by the assisted living service provider staff. Another assembling operation assembles any special dates associated with the client or the assisted living service provider. After the message components have been assembled, an integrating operation 2010 integrates the components into an integrated message that can be used to create a human-understandable message for delivery to a subscriber. A storing operation 2012 stores the integrated message so that it can be sent to or retrieved by the message builder of the IMDS. A notifying operation 2014 notifies the log manager regarding the integrated message for the subscriber.

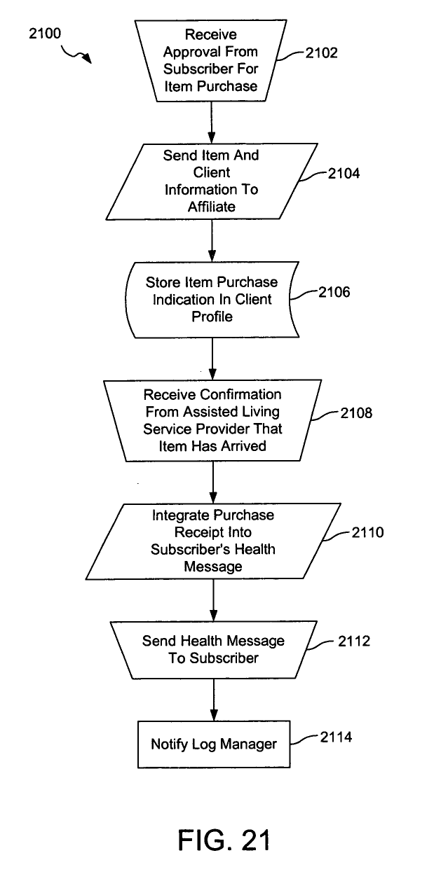

FIG. 21 illustrates and embodiment of a personal necessity fulfillment algorithm 2100 that can be carried out by the fulfillment module of the LTC notification service shown in FIG. 2, or another applicable module. Generally, fulfillment algorithm can be initiated in response to a request by a distribution community member to obtain a needed item for the client on behalf of the member. Thus, in a receiving operation 2102, the fulfillment module receives approval from a subscriber to purchase the needed item on behalf of the subscriber.

In a sending operation 2104 information regarding the client and the item is sent to an affiliate that is able to provide the requested item. In some embodiments, the affiliate is an online retailer. In other embodiments, the affiliate takes orders through a catalog. The client information can include name, address, or other client information. The item information can include item label (if labeled), color, type, size (e.g., for clothing), etc. The sending operation 2104 can also send billing information, such as the subscriber's credit card number, to the affiliate, so that the subscriber is automatically billed.

In a storing operation 2106 an indication that the item was ordered for the client is stored in the client's profile. The storing operation 2106 can store the date of order as well as the item information and the affiliate identifier. At some time in the future, when the item is delivered to the assisted living service provider, a staff member can access the message builder user interface to confirm that the item was received. A receiving operation 2108 receives the confirmation from the staff member, and stores a receipt script segment. In an integrating operation 2110, the receipt script segment is integrated with the health message that will be sent to the subscriber in the next message delivery.

In a sending operation 2112, the human-understandable message is delivered to the subscriber as described herein. The human-understandable message includes an audio or textual presentment of the receipt confirmation, letting the subscriber know that the item was received by the client. The receipt confirmation can include other information, such as the date of receipt by the client and the expression of the client upon receiving the item. A notifying operation 2114 notifies the log manager of the fulfillment processing.

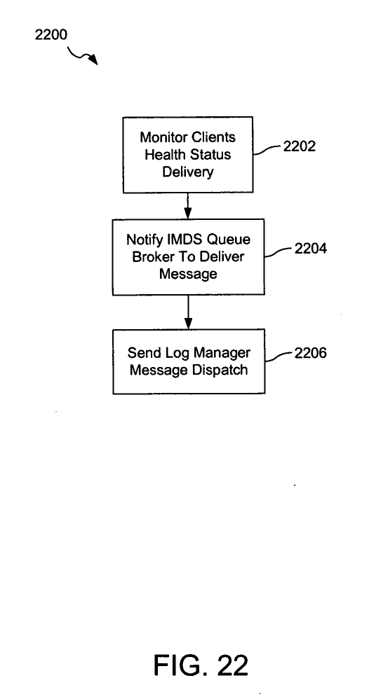

FIG. 22 illustrates and embodiment of a message distribution algorithm 2200 that can be carried out by the distributor of the LTC notification service shown in FIG. 2. The distributor generally manages when messages are sent to subscriber or other members of the distribution community. This is typically based on scheduled times that may have been selected by the subscriber or other members. The times may also be determined by communication capacity or bandwidth or system availability.

A monitoring operation 2202 monitors delivery of human-understandable messages to subscribers. In one embodiment, the monitoring operation 2202 determines when the last message was generated and sent for each client. The monitoring operation 2202 can determine when to generate and send the next message based on a calendar, based on profile information (e.g., subscriber's specified preferred times to receive messages), or based on whether LTC information has been obtained to create a message.

If the monitoring operation 2202 determines that it is time to deliver a message to a subscriber, a notifying operation 2204 notifies the queue broker of the IMDS to queue a message for delivery. The notifying operation 2204 can indicate a future time at which to trigger the process of message generation and/or delivery. The notifying operation 2204 can also indicate the subscriber or other member, as well as the client associated with the message. Another notifying operation 2206 then notifies the log manager that a message has been queued for delivery.

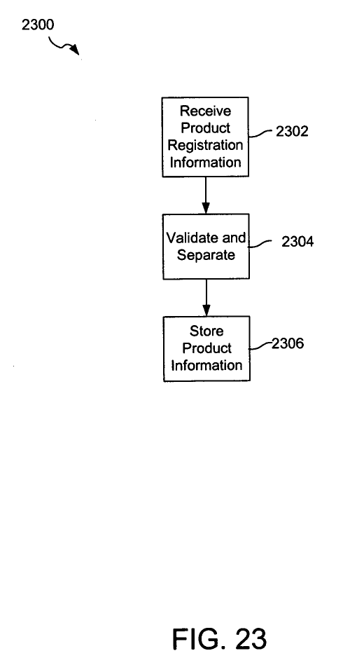

FIGS. 11-22 illustrate algorithms that can be carried out by modules of the LTC notification service in accordance with one embodiment of the invention. FIGS. 23-32 illustrate algorithms that can be carried out by modules of the IMDS in accordance with an embodiment of the invention. Although these algorithms are described as being carried out by the LTC notification service or the IMDS, it is to be understood that the LTC notification service and the IMDS could be combined into a common device, which performs the algorithms. Alternatively, functionality could be arranged in any other manner between the IMDS and the LTC notification service. For example, in one embodiment, the message building functions performed by the IMDS could be carried out by the LTC notification service.

FIG. 23 illustrates an exemplary embodiment of a application registration algorithm 2300 that can be performed by the IMDS manager 702. As discussed above, notification services can register one or more applications with the IMDS. In one embodiment, the IMDS manager 702 handles registration of applications according to the algorithm 2300.

In a receiving operation 2302 receives application registration information. This can include application name and description. A validating operation 2304 validates the received application registration information. In one embodiment, the application registration information will be stored in a relational database. As such, the application registration information is validated according to the rules of the relational database. Because the application registration information can be stored in multiple tables in the relational database, the validating operation 2304 also separates the application registration information for storage in the appropriate tables. A storing operation 2306 stores the separated application registration information in the appropriate tables of the relational database.

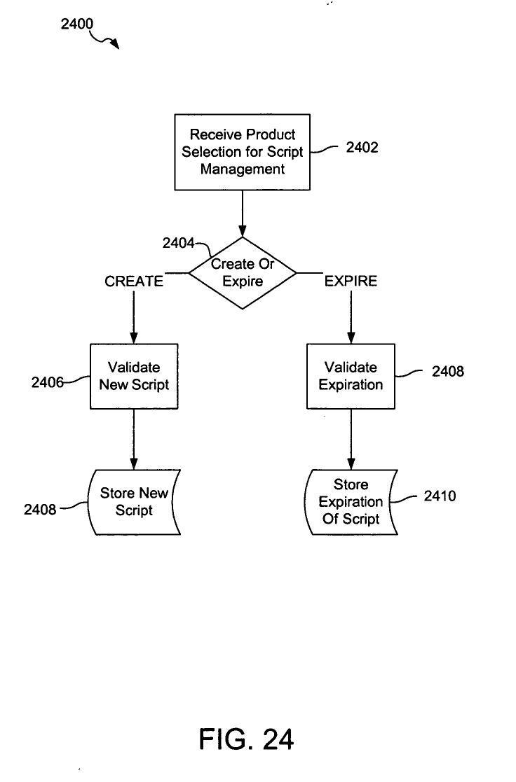

FIG. 24 illustrates an exemplary embodiment of a script management algorithm 2400 that can be performed by the IMDS manager 702. As discussed above, the IMDS provides an extensible script component dictionary. New script components can be created or expired. The algorithm 2400 generally involves the process of creating new script components and expiring unwanted script components.

A receiving operation 2402 receives an indication of a application for which a script component will be added or expired. In one embodiment, the receiving operation 2402 receives the indication through a web page interface. Also received through the web page interface is an indication whether a script component is to be created or expired.

A determining operation 2404 determines whether a script component is being added or expired. If a script component is being created, the algorithm 2400 branches “CREATED” to a validating operation 2406. The validating operation 2406 determines if the script component is valid (e.g., proper format, etc.). A storing operation 2408 stores the newly created script in a database.

If the determining operation 2404 determines that a script component is to be expired, the algorithm 2400 branches “EXPIRE” to another validating operation 2410. The validating operation 2410 checks to ensure that the expiration is valid. The validation process checks weather the script has been assigned for delivery during the next delivery period (e.g., the current week). If it has, the expiration date is set for the beginning of the following delivery period (e.g., the next week); else the script is expired immediately. If the expiration is valid, a storing operation 2412 stores the expiration of the script component. In one embodiment, the storing operation 2412 deletes the script component. In another embodiment, the storing operation 2412 marks the script component as expired so that it is not used.

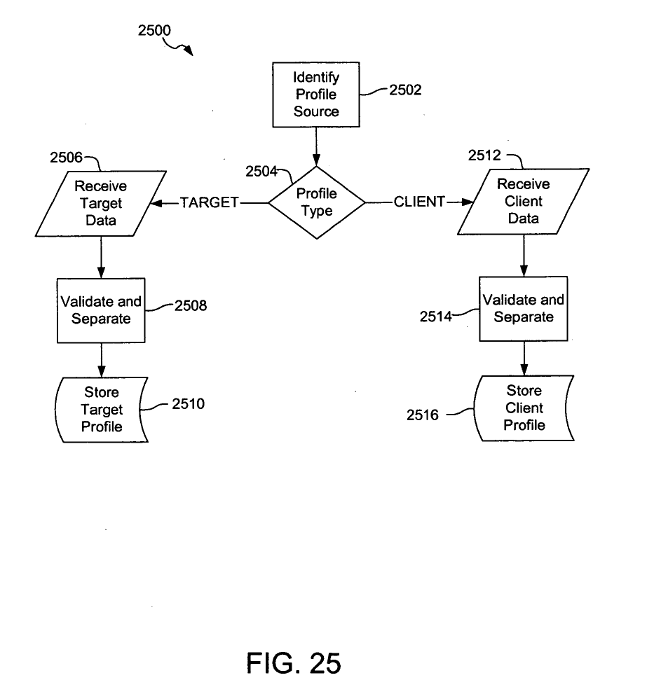

FIG. 25 illustrates an exemplary embodiment of a profile management algorithm 2500 that can be performed by the profile manager 706. The profile management algorithm 2500 generally enables a user (e.g., an administrator at a notification service) to create profiles for clients and targets (e.g., subscribers). When a notification service requests to create a new profile, an identifying operation 2502 identifies the type of profile. In one embodiment, a web page interface accepts input that identifies the type of profile.

A determining operation 2504 determines what type of profile is to be created. If the type of profile is a target profile, the algorithm 2500 branches “TARGET” to a receiving operation 2506. The receiving operation 2506 receives the profile information, such as target name, nickname, address, phone number, credit card, relationship to client, etc. A validating operation 2508 validates the target profile data according to rules of a relational database. In one embodiment, the rules pertain to data types and null values. If null values exist, then appropriate system defined defaults are assigned. In this embodiment, the profile data can be stored in multiple database tables. As such, the data is separated to be stored in the appropriate database table. A storing operation 2510 stores the separated profile data in the appropriate database table.

Referring again to the determining operation 2504, if the type of profile is a client profile, the algorithm 2500 branches “CLIENT” to a receiving operation 2512. The receiving operation 2512 receives the client profile information, such as client name, nickname, address, etc. A validating operation 2514 validates and separates the client profile data according to the rules of a relational database. A storing operation 2516 stores the separated profile data in the appropriate database table.

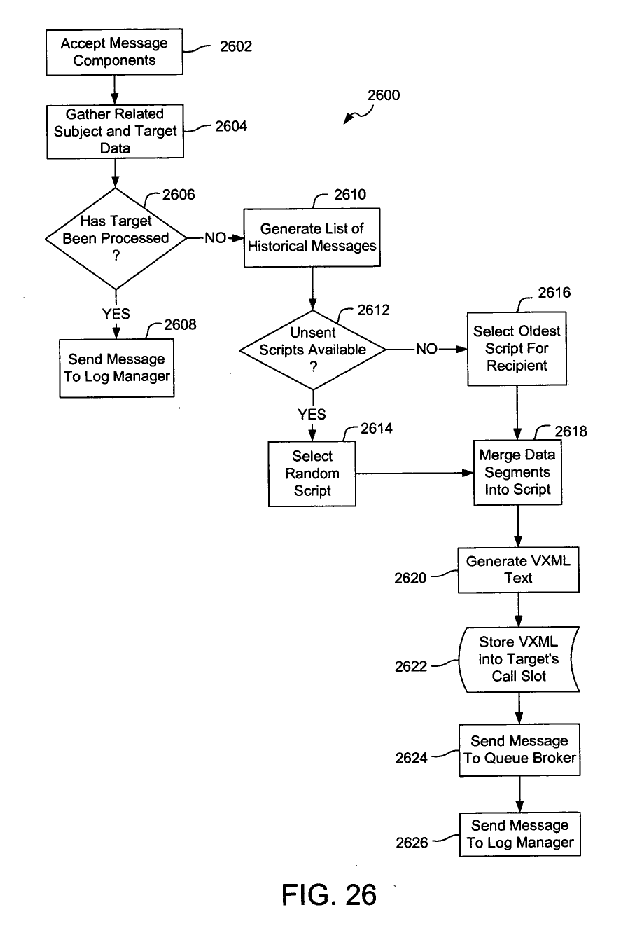

FIG. 26 illustrates an exemplary embodiment of a message building algorithm 2600 that can be performed by the message builder 710. Initially, a receiving operation 2602 receives message components. The message components may be received via the network (e.g., from a notification service) or from local memory. The message components include the script component identifiers that will be used to generate the message. The message components may also include data elements that can be merged with scripts to form the message. The receiving operation 2602 receives key information that identifies the target to receive the message and the associated client.

A gathering operation 2604 gathers data associated with the target and the client based on the key information. In one embodiment, the gathering operation 2604 accesses a target profile to determine the target's name, nickname, phone number, etc. The client profile may be accessed for the client's name, nickname, target relation, etc.

A determining operation 2606 determines whether the target has been processed. Generally, the determining operation 2606 identifies whether a message has already been generated for the target. If so, the algorithm 2600 branches “YES” to a sending operation 2608, which sends the message to the log manager 720. If the target has not been processed, the algorithm 2600 branches “NO” to a generating operation 2610.

The generating operation 2610 generates a list of messages that have previously been generated and/or delivered to the target. In one embodiment, the generating operation 2610 searches the log data 744 for historical messages associated with the target. A determining operation 2612 determines whether any scripts are available that have not been delivered to the target. The determining operation 2612 searches the available script templates 740 for any that are not in the list of historical messages.

If an unsent script is available in the available script templates 740, the algorithm 2600 branches “YES” to a selecting operation 2614. To achieve message freshness, the selecting operation 2614 selects an available unsent script at random. It is to be understood that selection of an unsent available script is not limited to a random selection. In other embodiments, the script may be selected according to a specified order, or based on events related to the content of the message, or others.

However, if an unsent script is not available in the available script templates 740, the algorithm 2600 branches “NO” to another selecting operation 2616. The selecting operation 2614 selects the least recently sent available script. After a script has been selected, in either the selecting operation 2614 or selecting operation 2616, a merging operation 2618 merges data elements with the selected script.

In one embodiment, a generating operation 2620 generates a VXML document based on the message. Generally, the generating operation 2620 adds VXML tags in the message that provide TTS processing information to a TTS system, so that the message can be converted from text to speech. TTS and conversion from text to speech is discussed further below with regard to the message delivery algorithm.

A storing operation 2622 stores the VXML document in a call slot associated with the target. A sending operation notifies the queue broker 708 that the message has been generated and is ready for delivery at the scheduled time. Another sending operation 2626 sends message generation status information to the log manager 720.

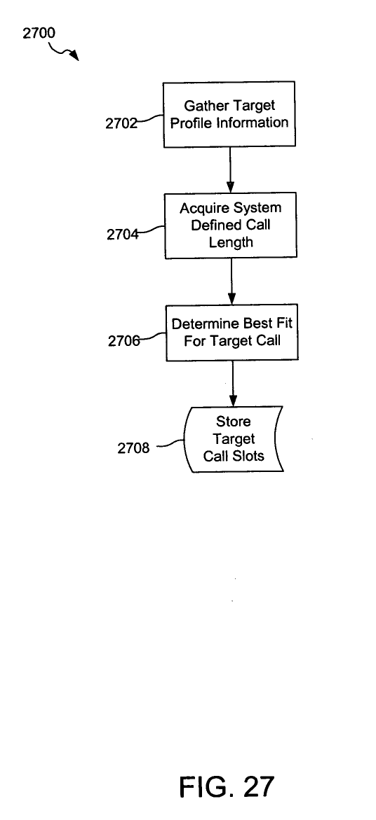

FIG. 27 illustrates an exemplary embodiment of a message scheduling algorithm 2700 that can be performed by the message scheduler 712. In general, the message scheduling algorithm 2700 schedules an available message in an appropriate call slot, so that the message will be delivered to a recipient at a specified time. Initially, a gathering operation 2702 gathers the recipient's profile information. The profile information specifies a service level and a time range (e.g., between 7:00 pm and 9:00 pm, Saturday night) that the recipient would prefer to have messages delivered.

An acquiring operation 2704 acquires a system defined call length. The system defined call length is a parameter that dictates the number of calls that can be handled. The system defined call length typically depends on the available physical hardware and telephony services. A determining operation 2706 determines the delivery time for the target call based on the recipient's profile and the system defined call length. A storing operation 2708 stores the message in a call slot associated with the determined delivery time.

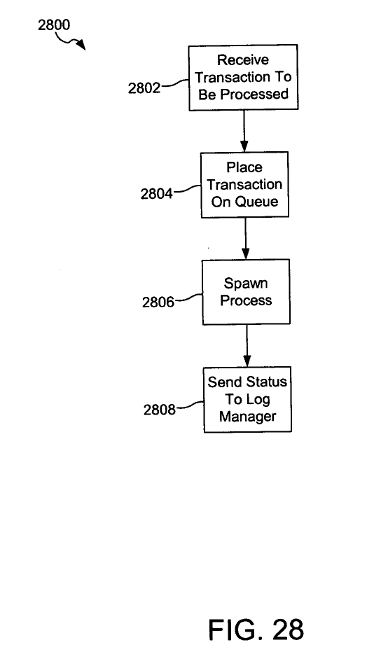

FIG. 28 illustrates an exemplary embodiment of a queue brokering algorithm 2800 that can be performed by the queue broker 708. Initially, a receiving operation 2802 receives a transaction to be processed. An example of a process that may be queued is a message delivery process. A placing operation 2804 places the transaction on the queue. The placing operation can involve choosing the proper queue and storing a reference to the transaction on the queue. The transaction is placed on the queue with an execution time.

When the execution time arrives, a spawning operation 2806 spawns (i.e., initiates) a process to perform the transaction. Spawning operation 2806 may include sending notification to an associated module in the IMDS to begin the transaction. For example, if the transaction is message delivery, the spawning operation 2806 notifies the message deliverer 714 to begin the process of delivering a message.

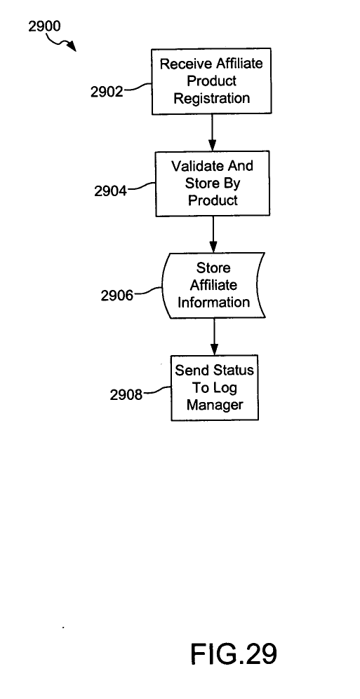

FIG. 29 illustrates an exemplary embodiment of a affiliate product brokering algorithm 2900 that can be performed by the service broker 704. Generally, a registered notification service may contact the IMDS to register an affiliate application. The service brokering algorithm 2900 handles the request. Initially, a receiving operation 2902 receives the request to register the affiliate application. The receiving operation 2902 receives information about the affiliate application to be registered, such as application provider, application name, description, associated script components, and so on.

A validating operation 2904 validates the information in the registration request. If the information is valid, the affiliate registration information is stored in storing operation 2906. In the validating operation 2904 affiliate information is validated against constraints within the relational database, and stored with appropriate associations to the desired application. Application associations allow for the affiliate partners to participate with selected IMDS application offerings. A sending operation 2908 sends status related to registration of the affiliate application to the log manager 720.

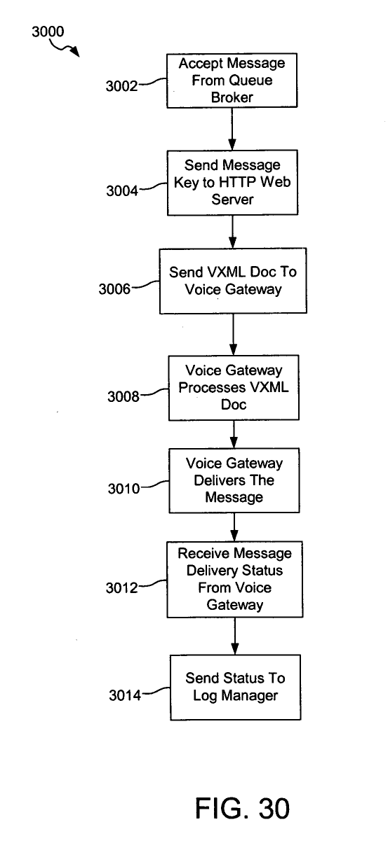

FIG. 30 illustrates an exemplary embodiment of a message delivery algorithm 3000 that may be carried out by the message deliverer 714. Initially, an accepting operation 3002 accepts a message from the queue broker. In this embodiment, the message includes a message key that indicates the recipient of the message, as well as a voice extensible markup language (VXML) document.

A sending operation 3004 sends the message key to an HTTP web server, where supporting information (i.e. the actual message, etc) is gathered about the client and/or the subscriber which supports the delivery. In the illustrated embodiment, another sending operation 3006 sends the VXML document to a voice gateway that can process the document and deliver the human-understandable message to the recipient.

A processing operation 3008 processes VXML data in the message. This typically involves performing text-to-speech (TTS) conversion on the message. The processing step is typically carried out by the voice gateway. Exemplary products that perform TTS include AT&T Natural Voices™, Loquendo TTS, VoiceText available from NeoSpeech Inc., Prosody available from Aculab, Elan SaySo available from Elan Speech, FAAST or DECTalk available from Fonix Corporation, VoiceServer available from IBM Corporation, LTTS available from Lucent Speech Solutions, Flex Voice available from Mindmaker, Vocalizer available from Nuance Communications, rVoice available from Rhetorical Systems, SoftVoice available from SoftVoice, Inc., Hybrid Orator II available from Telcordia Technologies, VoiceText available from Voiceware Co., Ltd., or the like.

In a delivering operation 3010, the human-understandable message is delivered to the recipient. In one embodiment, the recipient is contacted by telephone and the message is audibly presented to the recipient. During message presentation, the recipient may be prompted for various information, such as survey questions, request to purchase an item for a resident of a nursing home, or others. Any responses from the recipient will be captured and communicated back to the IMDS.

A receiving operation 3012 receives delivery status from the voice gateway. Delivery status indicates whether the message was successfully delivered, and can include responses from the recipient to prompts in the message. A sending operation 3014 sends the delivery status to the log manager.

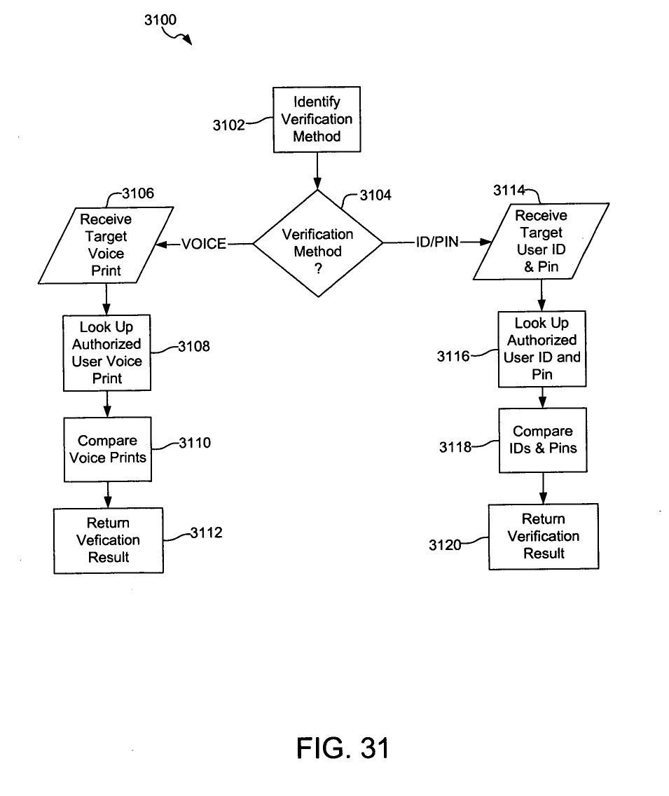

FIG. 31 illustrates an embodiment of a target verification algorithm 3100 that can be carried out by the verification manager 716. In general, the verification algorithm verifies whether a targeted recipient of a human-understandable message is authorized to receive the message. In some embodiments, more than one type of verification method may be available. Some recipients may be verified in one manner, while other recipients are verified in another manner.

As such, an identifying operation 3102 identifies the verification method associated with a recipient to be verified. The identifying operation 3102 can determine the verification method from the recipient's (or associated subscriber's) profile. A determining operation 3104 determines what type of verification method to use.

In one embodiment, the determining operation 3104 determines whether the verification method is voice verification or an ID/pin number verification. If the verification method is voice, the algorithm 3100 branches “VOICE” to a receiving operation 3106. The receiving operation 3106 receives a voice print from the target. This may involve having the target speak a specified phrase into the phone and capturing the spoken phrase in an encoded voice print.

A looking up operation 3108 looks up a corresponding authorized user's voice print. The looking up operation 3108 may access the authorized user's profile, which can include the voice print.

A comparing operation 3110 compares the target's captured voice print to the authorized user's voice print. If the two voice prints are substantially similar within a tolerance, the voice prints are considered the same and the target is successfully verified. If the two voice prints are not substantially similar within the tolerance, the voice prints are considered different and the target verification fails. A returning operation 3112 returns the status (e.g., either pass or fail).

Referring again to the determining operation 3104, if it is determined that ID and pin verification are to be used, the algorithm 3100 branches “ID/PIN” to a receiving operation 3114, which receives an ID and pin number from the target. Typically, the target enters the ID and pin via keypad, but they may also be entered via speech. If the ID and pin are received via speech, voice recognition is employed (for example, by the voice gateway) to determine the ID and pin.

Another looking up operation 3116 looks up a corresponding authorized user's ID and pin number. The looking up operation 3116 may access the authorized user's profile, which can include the ID and pin.

A comparing operation 3118 compares the ID and pin entered by the target to the authorized user's ID and pin. If the two IDs and pins match the target is successfully verified. If the two IDs and pins do not match, the target verification fails. A returning operation 3120 returns the status (e.g., either pass or fail).

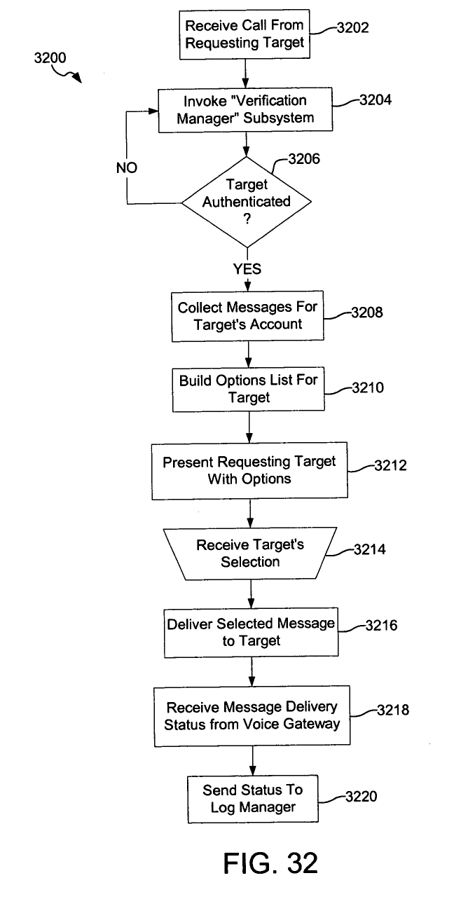

FIG. 32 illustrates an exemplary embodiment of a retrieving algorithm 3200 that may be carried out by the retriever module 716. Messages that have been generated and stored can be retrieved by a user. In a receiving operation 3202, the intelligent message delivery system (IMDS) receives a telephone call from a target user. Generally, users can dial a telephone number associated with the notification service that provides the application the target is subscribed to. In one embodiment, the call goes through a voice gateway and is routed to the IMDS.

An invoking operation 3204 invokes the verification manager 716 to collect the user's account information and verify whether the calling target user is an authorized user. In one embodiment, the IMDS instructs the voice gateway to invoke the verification manager 716. A determining operation 3206 determines whether the target user is authorized. If verification is not successful, the algorithm 3200 branches “NO” back to the invoking operation 3204, where verification is attempted again. Verification of the target may be limited to a specified number of attempts.

If verification is successful, the algorithm 3200 branches “YES” to a collecting operation 3208. The collecting operation 3208 collects any available messages associated with the target's account. A building operation 3210 builds a document listing the available messages for the target. In one embodiment, the document is a VXML document that can be audibly presented to the target. A presenting operation 3212 presents the list of available messages to the target. In one embodiment, the IMDS causes a voice gateway to present the list of available messages audibly. The presenting operation 3212 enables the target to select one or more of the messages for delivery.

A delivering operation 3214 delivers the selected message(s) to the target. In one embodiment, the delivering operation causes the voice gateway to deliver the selected message(s) to the target. A receiving operation 3216 receives status related to delivery of the message(s). In one embodiment, the message delivery status is received from the voice gateway. A sending operation 3218 sends the message delivery status to the log manager 720.

Exemplary Computing Device

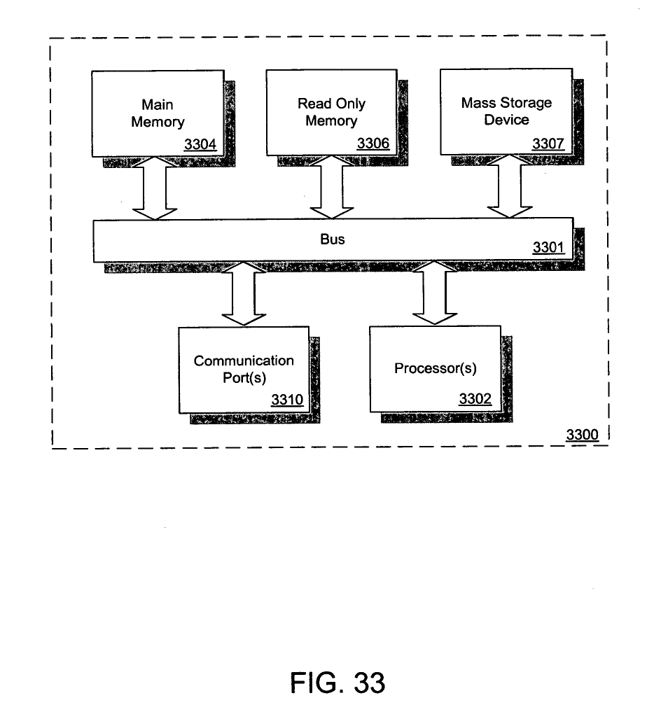

FIG. 33 illustrates an exemplary machine in the form of a computer system 3300. The computer system 3300 is representative of many types of computing devices and systems, such an exemplary database server or web server, in which features of the present invention may be implemented will now be described with reference to FIG. 33. In this simplified example, the computer system 3300 comprises a bus or other communication means 3301 for communicating information, and a processing means such as one or more processors 3302 coupled with bus 3301 for processing information.

Computer system 3300 further comprises a random access memory (RAM) or other dynamic storage device 3304 (referred to as main memory), coupled to bus 3301 for storing information and instructions to be executed by processor(s) 3302. Main memory 3304 also may be used for storing temporary variables or other intermediate information during execution of instructions by processor(s) 3302. Computer system 3300 also comprises a read only memory (ROM) and/or other static storage device 3306 coupled to bus 3301 for storing static information and instructions for processor 3302. A data storage device 3307 such as a magnetic disk or optical disc and its corresponding drive may also be coupled to bus 3301 for storing information and instructions.

One or more communication ports 3310 may also be coupled to bus 3301 for allowing communication and exchange of information to/from with the computer system 3300 by way of a Local Area Network (LAN), Wide Area Network (WAN), Metropolitan Area Network (MAN), the Internet, or the public switched telephone network (PSTN), for example. The communication ports 3310 may include various combinations of well-known interfaces, such as one or more modems to provide dial up capability, one or more 10/100 Ethernet ports, one or more Gigabit Ethernet ports (fiber and/or copper), or other well-known interfaces, such as Asynchronous Transfer Mode (ATM) ports and other interfaces commonly used in existing LAN, WAN, MAN network environments. In any event, in this manner, the computer system 3300 may be coupled to a number of other network devices, clients and/or servers via a conventional network infrastructure, such as a company's Intranet and/or the Internet, for example.

Embodiments of the present invention may be provided as a computer program product which may include a machine-readable medium having stored thereon instructions which may be used to program a computer (or other electronic devices) to perform a process according to the methodologies described herein. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media / machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

The tables shown and described herein are for illustrative purposes only in order to illustrate how one skilled in the art could create a data structure in accordance with various embodiments. In particular embodiment's data structures are not limited to those illustrated by the tables. It will be understood that values in an application product-specific script components data structure are not limited to those shown in tables described herein. In addition, the arrangement of values is not limited to the arrangements shown in the tables.

The functional modules, systems, operations, and data structures discussed herein are capable of combination, separation, or any other type of rearrangement without departing from the spirit scope of the claims recited below. For example, the notification service may be combined with the service provider or the intelligent message delivery system. Data structures shown and described can be implemented in any format known to those skilled in the art including, but not limited to extensible markup language (XML), as entries in a relational database, or any proprietary format.

Although some exemplary methods, systems, and devices have been illustrated in the accompanying drawing and described in the foregoing detailed description, it will be understood that the methods and systems shown and described are not limited to the particular embodiments described herein, but rather are capable of numerous rearrangements, modifications, and substitutions without departing from the scope and spirit of the claims set forth below.

1. A method for delivering a message to a recipient, the message associated with a client of an assisted living service provider, the method comprising:
gathering long term care information from a records repository;
encoding at least some of the long term care information into predefined codes associated with predefined script segments;
causing a script to be generated using the script segments;
causing a human-understandable message to be delivered to the recipient according to a schedule.

2. A method as recited in claim 1 further comprising generating a subscriber profile having information about a subscriber who is authorized to receive long term care information about the client.

3. A method as in claim 2 wherein the subscriber profile information comprises one or more of a preferred time to receive human-understandable messages, identifications of members in a distribution community associated with the client, one or more categories of long term care information that the subscriber wants to be notified about.

4. A method as recited in claim 1 wherein gathering comprises directly retrieving the long term care information from any records repository.

5. A method as recited in claim 1 wherein gathering comprises presenting a user interface through which a user associated with the assisted living provider can enter long term care information.

6. A method as recited in claim 1 wherein gathering comprises gathering information related to one or more adverse events associated with the client.

7. A method as recited in claim 6 further comprising automatically notifying a governmental entity of the adverse events.

8. A method as recited in claim 1 wherein causing a human-understandable message to be delivered to the recipient comprises:
causing the script to be converted into a human-understandable message in an audible format;
causing the human-understandable message to be delivered in the audible format.

9. A method as recited in claim 1 further comprising defining categories of long term care information that can be gathered from the assisted living service provider.

10. A method as recited in claim 3 further comprising generating a subscriber profile management user interface accessible by the subscriber, through which the subscriber can modify the information in the subscriber profile.

11. A method as recited in claim 1 further comprising:
capturing a response from the recipient, the response indicating approval to purchase an item needed by the client on behalf of the recipient;
automatically ordering the item;
causing the item to be delivered to the client on behalf of the recipient;
receiving confirmation from the assisted living service provider that the item was received;
causing another human-understandable message to be delivered to the recipient to notify the recipient that the item was received by the client.

12. A method as recited in claim 11 wherein the another human-understandable message includes information descriptive of the client's expression when the client received the item.

13. A system for delivering a message related to long term care of a client serviced by an assisted living service provider, the system comprising:
an administration module providing an administration user interface enabling definition of a plurality of script components that can be used to describe long term care of the client;
a message builder module providing a message builder user interface enabling a user associated with the assisted living service provider to record long term care information about the client, and generating a script using selected script components associated with the long term care information; and
a distributor module operable to cause the script to be converted into a human-understandable message that is delivered to a message recipient.

14. A system as recited in claim 13 wherein at least some long term care information is provided by a third party system.

15. A system as recited in claim 13 wherein the distributor module is operable to cause the script to be converted into an audible human-understandable message using a text-to-speech system.

16. A system as recited in claim 13 wherein the long term care information includes supplemental information including one or more of a personal necessity identifying an item needed by the client, one or more survey question, one or more reasons for the human-understandable message, one or more actions taken with respect to the long term care information, one or more dates associated with the client.

17. A system as recited in claim 13 wherein the long term care information specifies an item needed by the client, and wherein the human-understandable message includes a prompt for the message recipient to approve automatically providing the item to the client on behalf of the message recipient.

18. A system as recited in claim 17 further comprising a fulfillment manager operable to order the needed item in response to approval to automatically provide the needed item.

19. A system as recited in claim 13 further comprising an adverse events module operable to capture adverse event information related to the client and cause the adverse event information to be automatically delivered to a governmental entity.

20. A computer-readable medium having computer-executable instructions that, when executed, cause a computer to carry out a process for communicating information about a client of an assisted living service provider from the assisted living service provider to a recipient, the process comprising:
defining a plurality of script segments, each script segment associated with a value related to a category of long term care of an individual;
receiving a selected value from the plurality of values, the selected value characterizing a corresponding category of long term care of the individual;
selecting a script segment associated with the selected value, the script segment being for use in generating a human-understandable message.

21. A computer-readable medium as recited in claim 20 further comprising:
defining a plurality of categories of long term care information;
defining at least one element associated with each category;
defining at least one sub-element associated with each element; and
defining at least one value associated with each sub-element, wherein the categories, elements, sub-elements, and values can be used to create a script descriptive of long term care of the client.

22. A computer-readable medium as recited in claim 20 wherein receiving comprises receiving the selected value from a user interface in communication with the Internet.

23. A computer-readable medium as recited in claim 20 wherein defining comprises defining a tagged segment readable by a text-to-speech system for converting the selected segment into a human-understandable message in an audio format.

24. A computer-readable medium as recited in claim 23 wherein the process further comprises causing the human-understandable message to be delivered in the audio format.

25. A computer-readable medium as recited in claim 20, wherein the process further comprises:
receiving identification of an item needed by the client from the assisted living service provider;
causing the human-understandable message to be delivered to the recipient, wherein the human-understandable message includes a prompt for the recipient to approve ordering the needed item for the client;
automatically ordering the needed item if the recipient approves ordering of the item.
